(19) United States
(12) Patent Application Publication
(10) Pub. No.: US 2016/0071152 A1
(43) Pub. Date: Mar. 10, 2016

(54) SYSTEM AND METHOD FOR DYNAMIC CLIENT RELATIONSHIP MANAGEMENT (CRM) AND INTELLIGENT CLIENT ENGAGEMENT

(71) Applicant: APPRECIE LIMITED, London (GB)

(72) Inventors: Susannah Elizabeth Nicklin, Marlow (GB); Lara Peperell, Marlow (GB)

(73) Assignee: APPRECIE LIMITED, London (GB)

(21) Appl. No.: 14/942,646

(22) Filed: Nov. 16, 2015

Related U.S. Application Data
(63) Continuation-in-part of application No. 14/197,082, filed on Mar. 4, 2014.
(60) Provisional application No. 61/772,222, filed on Mar. 4, 2013.

(51) Int. Cl. G06Q 30/02

(52) U.S. Cl. CPC G06Q 30/0255; G06Q 30/0226; G06Q 30/0273; G06Q 30/0214

(57) ABSTRACT

A system and method for dynamic client relationship management and intelligent client engagement is disclosed. The system collects user information and allows internal Licensee user groups to better know and serve their clients and clients' families, as well as qualified prospects, by providing a customized invitation-only portal with VIP offers and events, corporate hospitality, and exclusive arrangements based on specific client profiles and user segmentation, within a configurable hosted platform securely accessible and optimized for web and mobile devices. The platform facilitates and manages dynamic CRM, moving beyond existing CRM formats where one user or data feed enters data about another individual into a system. The data captured is dynamically augmented based on users' expressed interests and actual behaviors and interactions across sectors and industries, thus facilitating two way data flow, capture, analysis, and predictive promotion of exclusive goods, services or other information, by different companies serving common customer bases.

### CROSS-REFERENCE TO RELATED APPLICATION

This application is a continuation-in-part of U.S. patent application Ser. No. 14/197,082 filed on Mar. 4, 2014, that claims priority to Provisional Application Ser. No. 61/772,222 filed on Mar. 4, 2013, and is incorporated herein by reference in its entirety.

### FIELD OF INVENTION

The field of the invention relates to business methods involving client engagement, online marketplaces, and social networking.

### BACKGROUND

Financial Services and other professional services firms—for many reasons—often systematically capture very little insight into the personal interests of their clients. Yet personal circumstances and preferences have been shown to dictate financial choices just as much as other consumer choices. Further, these firms often do not have sophisticated marketing approaches nor large marketing budgets—and yet their clients are demanding, the market is competitive and the products are increasingly commoditized.

These firms also rarely align marketing expenditures or activities with expected outcomes systematically, and do not have mechanisms for tracking the impact of marketing expenditures or activities on client or prospective client behavior, or vice versa, for capturing data on client behavior and preferences to inform marketing choices.

Firms also have a significant problem in that there is often little incentive for Relationship Managers to record the details of interactions with their clients on Client Relationship Management (CRM) systems, and detailed personal client knowledge is often kept in the Relationship Manager's “little black book” or in their head. This creates vulnerability and risks for the firm should the relationship manager leave or transfer. Further, there are no similar platform tools available to these account managers to use to extend their relationship/interactions with a primary account holder to his or her broader family and other generations in a systematic, dynamic way. However, creating systematic multi-generational client engagement can be vital for long-term business success.

Another challenge in supporting High to Ultra High Net Worth (H/UHNW) members is a requirement to explicitly segregate client data that can only be accessed through a licensee gatekeeper (member of wealth management organization that supports H/UHNW members). Further, luxury brand and prestige organizations desire to prequalify H/UHNW members for certain events and unique offerings that may not be available to a wealth management organization's entire client list.

The present application discloses a system and method for targeted engagement—including two-way communication, marketing, events programming, loyalty rewards and special offers, and corporate hospitality—to existing and new qualified clients, in a highly cost-effective and exclusive way. It also includes a powerful database with a front-end application to manage and analyze front-line engagement activity, and to generate useful data regarding a company's market positioning, client perception, and to assist the licensee when developing products, campaigns and promotions.

In the presently disclosed platform, users (“Users,” “Members,” “Internals,” “Clients,” or “Managers”) gain a tool for accessing the luxury or other selected market(s) with sophisticated personalization and special access/benefits based on their circumstances, interests, and corporate affiliations.

On the other side, the platform “Suppliers” (e.g., luxury goods companies, arts & culture organizations, and typically other firms in the prestige goods or services sectors) face a challenge in increasing market share in today's complex sales landscape. Globalization, the internet, and the rise of e-commerce have created a critical evolution in the luxury market resulting in the need for highly personal service and the rise of “experiential” loyalty programs—i.e., using events, tours and VIP services, access and other support to differentiate a brand or product, inspire affection, and engender loyalty. Luxury goods companies and other firms in the prestige sector, whose market also is the High to Ultra High Net Worth (H/UHNW) individual or family, find it increasingly difficult to target their VIP marketing effectively, especially in any sustainable, long-term way, or, to reach beyond their existing VIP customers to new qualified H/UHNW customers—those who are potential VIP customers with the capacity to generate meaningful revenues—cost effectively through elite-closed channels that do not dilute their brand or VIP offerings.

In addition, the Luxury Market is increasingly looking at better ways to form a “community” of their VIP clients in a more formalized way. At present, their VIP program systems are often rudimentary and rarely capture deep insights into the personal interests of their clients and their clients' families. Their VIP clients are demanding, and want to be recognized and taken care of in a special manner, which can be difficult without a systematic approach to knowing and caring for these clients. In addition, the market is becoming increasingly competitive and loyalty can be difficult to generate.

Marketing teams often find it difficult to directly align return on investments (ROI) with expenditure on VIP events and special treatment as they do not have mechanisms for tracking the impact of marketing expenditures on client behavior, or vice versa, for capturing data on client behavior and preferences to inform marketing and engagement choices.

Further, these companies also face similar challenges in regard to the risks of losing VIP insights when their own Relationship Managers/Sales People leave or transition, and in reaching across generations and into families. The lack of a centralized record of VIP Client knowledge is a vulnerability for Luxury Brands/Prestige Partners as this very valuable personal client knowledge can also be kept in the Relationship Manager/Sales Person's “little black book” or in their head. This creates significant risks for the Brand should the sales person leave. Further, there are no similar platform tools available to these VIP Client teams to use to extend their relationship/interactions with a primary account holder to his or her broader family and other generations; creating systematic multi-generational client engagement can be vital for long-term business success.

The ability to track “dynamic” client knowledge, supplied not just via the perspective of the Relationship Manager/Sales Person, but also by recording of the client's preferences expressed through their choices, behaviors and interaction, is significantly more valuable and accurate than traditional CRM systems. Additionally the system and method provides for tiering of clients as determined by the Relationship Manager. The tiering feature can be used to qualify whether a particular client should be provided access to luxury product or exclusive events, that have defined tier requirement.

The use of the platform for Luxury Brands/Prestige Firms as a VIP Client Platform, a new channel for marketing and distribution and, and as a supplier for the exclusive not publically available experiences to the qualified clients of other Platform Licensees is a significant step forward in VIP client communication, retention, and acquisition.

### SUMMARY

The present application discloses a system and method for ‘private club’ or ‘closed community’ client engagement/acquisition platform for companies or organizations (Licensees′) serving a specific demographic or target market such as High to Ultra High Net Worth individuals (such Licensees to include but not limited to private banks, wealth managers and other financial and professional services firms, or other prestige companies).

Membership is provided as part of their client servicing by the Licensees to their best clients (for example clients with assets managed >£1 million) and to their relevant internal users, such as Marketing Managers and Relationship Managers. Primary account holders are also able to invite up to three (or more if required) family members to become members as well. This facilitates access to the exquisite and exclusive events and benefits offered by the Licensee and affiliate partners or sponsors and, if desired, to the content (events, offers, access, special benefits, etc.) provided by the Apprecie range of prestige partner suppliers to the platform. The platform disclosed in the present application helps Licensees understand their clients better, and engage with them more personally, regularly, creatively and cost-effectively. It helps them identify and quantify the success or otherwise of marketing and engagement activities and events with groups of specific commercial interest, in order to help guide marketing and business development strategies and planning in alignment with business priorities. The system and method disclosed addresses client dissatisfaction with their service providers or Relationship Managers because of poor client service experience. It also addresses the missed commercial opportunities and frustration at the management or marketing team level with their poor understanding of Return on Marketing Spend and/or with time-consuming, low-value-add workflows involved with running event and corporate hospitality programs.

The disclosed system and method satisfies the requirement for explicit segregation of client data between Wealth Management Organization and Suppliers. The system disclosed implements complex access controls in which each Portal is created with its own configuration and client database but Supplier services are held within a Global Services database with access being provided by either Role Based Permission within a Portal or Publication Controls between portals.

In a similar use case for a different market segment, the application discloses a system and method for a virtual ‘private club’ or ‘closed community’ VIP client engagement/acquisition platform for Luxury Brands/Prestige Partners (Licensees) to evolve their VIP Programs to better meet the needs of their clients and, if desired, to cross sell with aligned prestige partners. Membership is provided to VIP clients (typically having a very high annual spend at a Suppliers) and to their VIP Client Services Teams. Primary account holders are also able to invite up to three (or more if required) family members to become members as well, creating a cross-generational approach. This facilitates access to the exquisite and exclusive events and benefits offered by the Suppliers and, if they would like to extend further offers, to a range of aligned prestige partners, creating an intelligent market analysis of complementary brands. The platform disclosed in the present application helps Marketing Managers and VIP Client Services Teams to understand their best VIP clients better, and engage with them more personally, regularly, creatively and cost-effectively and gain cross-sector market data in a more targeted personalized manner.

There is an opportunity for this to become an aggregated VIP Program Platform, allowing Luxury Brands/Prestige Partners to cross-sell to other non-competing Luxury Brands/Prestige Partners' VIP clients, creating a further overlapping circle of qualified U/HNW clients, with a common mechanism for personalized engagement and aggregated benefits.

The present system and method enables companies to shift from or extend their one-dimensional sales or “Client Relationship Management” to Dynamic Client Relationship Management and Intelligent Client Engagement. On embodiment focuses on companies serving High to Ultra

(H/UHNW) individuals and families. However, the technology and business concept has further applications as a highly intelligent business to business (B2B) mechanism:
for affiliating companies serving common customer bases across different industries or markets, and
disintermediating the selection and management of corporate hospitality, allowing the ‘front-line’ users of corporate hospitality (typically high-value relationship managers or account managers) to have greater choice, access and accountability, and optimizing the processes of sourcing, purchasing and allocating corporate hospitality opportunities.

The data captured moves beyond existing CRM formats where another person enters data about the individual into a system, to one which can augment data with information driven by the individual's expressed interests, behaviors and interactions, combining and facilitating two way data flow, ‘gamification’ to encourage or reward engagement, and data capture.

The platform also provides a new marketing, sales and distribution channel for Luxury Brands/Prestige Partners to forge close relationships, share their narratives and promote targeted VIP experiences and offers to qualified high net worth individuals and families globally, both to their own VIPs and to the best U/HNW clients of the professional services firms and the VIP clients of non-competing brands. This addresses one of the key challenges in the luxury sector in connecting Suppliers businesses directly with their appropriate client demographic.

One of the ways the present system and method achieve intelligent client management is a feature called the Vault (or the Member's Vault) that can be comprised of one or more highly curated and tagged databases of content from our Suppliers (e.g., Luxury Brands/Prestige Partners)—and supplemented by content created or supplied by the Licensee itself (or its own partners) if desired (and depending on the configured package purchased by the Licensee). The system includes Dashboards and Settings pages for the Administrators, Marketing Managers, Relationship Managers/Sales Teams, and the Partners/Suppliers. These Dashboards and related interfaces permit particularly valuable functionality.

The Dashboard and Settings features allow firms to enhance the client experience in an interactive way, by gathering client interests and directly tracking Client-Relationship Manager engagement. Patterns of behavior and demographic insights help Licensees know their clients better, to target communications and facilitate better servicing and product development. Feedback may be gathered and analyzed as well, and engagement histories preserved within the firm to ensure continuity of service as Relationship Managers/Sales Teams leave or change. The system provides dynamic and systematic linking of client engagement with specific client interests, and provides tools to measure the impact of marketing expenditure on a regular basis. Previously, the approaches to client engagement are based on convention and intuition, rather than innovation and analysis, and do not allow for personalization of the client experience. Also, previous systems rarely have any efficient way to extend the relationship beyond the primary account holder and build or reward loyalty with family members. The present system and method creates a mechanism to do all of this, and to be customized/configured for Licensees' own branding and workflows.

The system and method also will have application for other client/customer engagement enhancement in different sectors. The platform facilitates and manages dynamic CRM, allowing data to be dynamically captured across natural network groups (families or otherwise) of a firm's clients, and creates a mechanism for productive business-to-business affiliations between firms serving the same target market with different products/services.

In one embodiment, the system and method will provide for relationship managers to offer other types of benefits, products or services other than luxury goods such as financial services, entertainment, vacation, travel, real estate, and charitable opportunities. The system assists a relationship manager to better match services and products with a client and the client's family particular needs or interests and ensures offers are made available only to clients or the clients family that are appropriately tiered or qualified.

On embodiment of the System incorporates six User Interfaces and associated pages, which interact dynamically and include configurable modules which can be structured or configured as packaged “products”. These User Interfaces comprise:

User Interface for the Licensee Portal Administrator—to manage user permissions, the content displayed or included on their Member Vault, to analyze activity, and to support and engage with users.

User Interface for Marketing Managers (and related hierarchies)

User Interface for Relationship Managers (and related hierarchies)

User Interface for Members and Family Members (and potentially other qualified associated people)

User Interface for Suppliers (Partners)—to upload, manage and track offers/responses/purchases; paid for by annual tenancy and/or commission arrangements.

User Interface for the Apprecie. and its related entities to manage the configured products and platforms (e.g., the “Professional”, “Enterprise”, “VIP”, and “Integrated” packages), with options for portability to any appropriate hosted environment globally and a spectrum of customization according to product specification.

These and other features of the invention will be more readily understood upon consideration of the attached drawings and of the following detailed description of those drawings and the presently-preferred and other embodiments of the invention.

### BRIEF DESCRIPTION OF THE DRAWINGS

FIG. 1 illustrates the operating space for the system and method disclosed herein as related to suppliers, licensees and wealth owners.

FIG. 2 is an exemplary diagram illustrating an embodiment of the system layers.

Table 1 illustrates the features available for different users in one embodiment of the disclosed system and method.

Table 2 illustrates the system permutations available for different users in one embodiment of the disclosed system and method.

FIG. 3 illustrates one embodiment of the relationship between different modules of the disclosed system and methods.

FIG. 4 illustrates one embodiment of the member module.

FIG. 5 illustrates one embodiment of the supplier modules.

FIG. 6 illustrates one embodiment of the licensee relationship manager module.

FIG. 7 illustrates the portability of the system.

FIG. 8 illustrates an embodiment of a system configuration.

FIG. 9 illustrates the process when a licensee is a supplier.

FIG. 10 illustrates an embodiment of the Admin Dashboard.

FIG. 11 illustrates an embodiment of the Relationship Manager dashboard.

FIG. 12 illustrates an embodiment of a Relationship Manager Client list dashboard.

FIG. 13 depicts an embodiment of the member dashboard.

FIG. 14 depicts an embodiment of the member vault page.

FIG. 15 depicts an embodiment of the benefits page.

FIG. 16 depicts an embodiment of the supplier (brand partner) client list page.

FIG. 17 depicts the member user processes.

FIG. 18 depicts the relationship manager user processes.

FIG. 19 depicts the administrator platform user processes.

FIG. 20 depicts the supplier user processes.

FIG. 21 is an exemplary drawing illustrating one embodiment of the data isolation entities.

FIG. 22 is an exemplary drawing illustrating one embodiment of the Entity Relationships that support data isolation.

FIG. 23 is an exemplary drawing illustrating a data isolation condition.

FIG. 24 is an exemplary drawing illustrating another data isolation condition.

FIG. 25 is an exemplary drawing illustrating another data isolation condition.

FIG. 26 is an exemplary line drawing illustrating the relationship of information across organizational hierarchies.

FIG. 27 is an exemplary flow diagram illustrating an embodiment of the method for dynamic client engagement.

FIG. 28A is a beginning of an exemplary flow diagram illustrating another embodiment of the method for dynamic client engagement.

FIG. 28B is an end of an exemplary flow diagram illustrating another embodiment of the method for dynamic client engagement.

FIG. 28 is a compilation of FIG. 28A and FIG. 28B.

FIG. 29A is a beginning of an exemplary flow diagram illustrating another embodiment of the method for dynamic client engagement.

FIG. 29B is an end of an exemplary flow diagram illustrating another embodiment of the method for dynamic client engagement.

FIG. 29 is a compilation of FIG. 29A and FIG. 29B.

FIG. 30A is a beginning of an exemplary flow diagram illustrating another embodiment of the method for dynamic client engagement.

FIG. 30B is an end of an exemplary flow diagram illustrating another embodiment of the method for dynamic client engagement.

FIG. 30 is a compilation of FIG. 30A and FIG. 30B.

FIG. 31A is a beginning of an exemplary flow diagram illustrating another embodiment of the method for dynamic client engagement.

FIG. 31B is an end of an exemplary flow diagram illustrating another embodiment of the method for dynamic client engagement.

FIG. 31 is a compilation of FIG. 31A and FIG. 31B.

FIG. 32A is a beginning of an exemplary flow diagram illustrating another embodiment of the method for dynamic client engagement.

FIG. 32B is an end of an exemplary flow diagram illustrating another embodiment of the method for dynamic client engagement.

FIG. 32 is a compilation of FIG. 32A and FIG. 32B.

FIG. 33A is a beginning of an exemplary flow diagram illustrating another embodiment of the method for dynamic client engagement.

FIG. 33B is an end of an exemplary flow diagram illustrating another embodiment of the method for dynamic client engagement.

FIG. 33 is a compilation of FIG. 33A and FIG. 33B.

FIG. 34A is a beginning of an exemplary flow diagram illustrating another embodiment of the method for dynamic client engagement.

FIG. 34B is an end of an exemplary flow diagram illustrating another embodiment of the method for dynamic client engagement.

FIG. 34 is a compilation of FIG. 34A and FIG. 34B.

FIG. 35A is a beginning of an exemplary flow diagram illustrating another embodiment of the method for dynamic client engagement.

FIG. 35B is an end of an exemplary flow diagram illustrating another embodiment of the method for dynamic client engagement.

FIG. 35 is a compilation of FIG. 35A and FIG. 35B.

FIG. 36 is an exemplary flow diagram illustrating an embodiment of the method for dynamic client engagement.

FIG. 37 is an exemplary flow diagram illustrating an embodiment of the method for dynamic client engagement.

FIG. 38A is a beginning of an exemplary flow diagram illustrating another embodiment of the method for dynamic client engagement.

FIG. 38B is an end of an exemplary flow diagram illustrating another embodiment of the method for dynamic client engagement.

FIG. 38 is a compilation of FIG. 38A and FIG. 38B.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

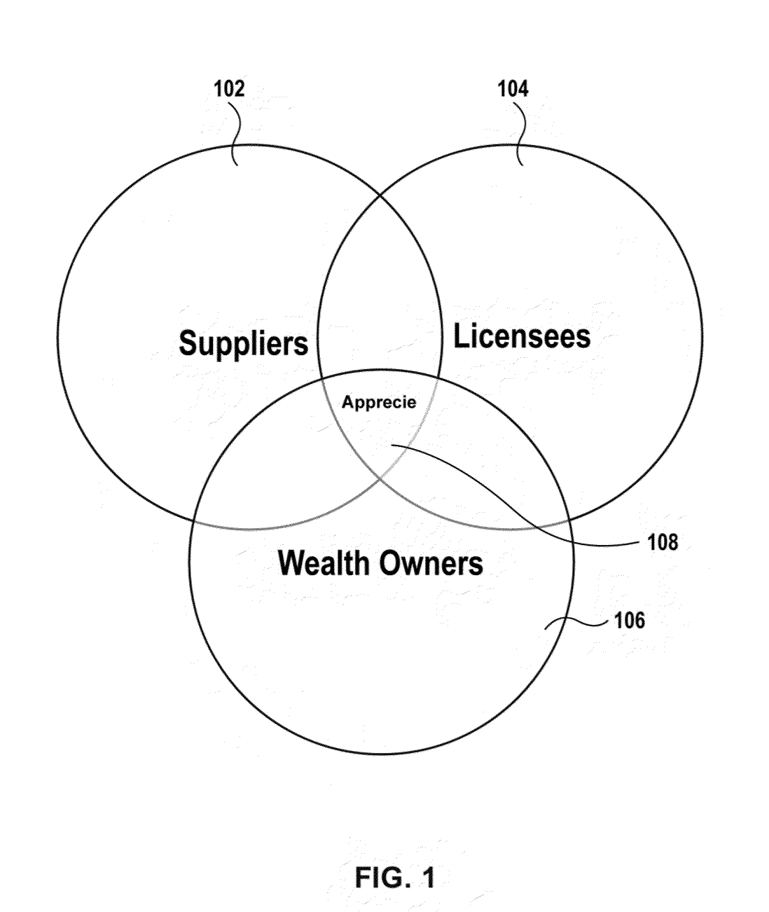

FIG. 1 illustrates the operating space for the system 100 and method 1200 disclosed herein as related to suppliers 102, licensees 104 and wealth owners 106. The disclosed platform 108 is designed to match offers from suppliers 102 with licensee's 104 client portfolio in order to best serve, unique, high value items and events to wealth owners 106.

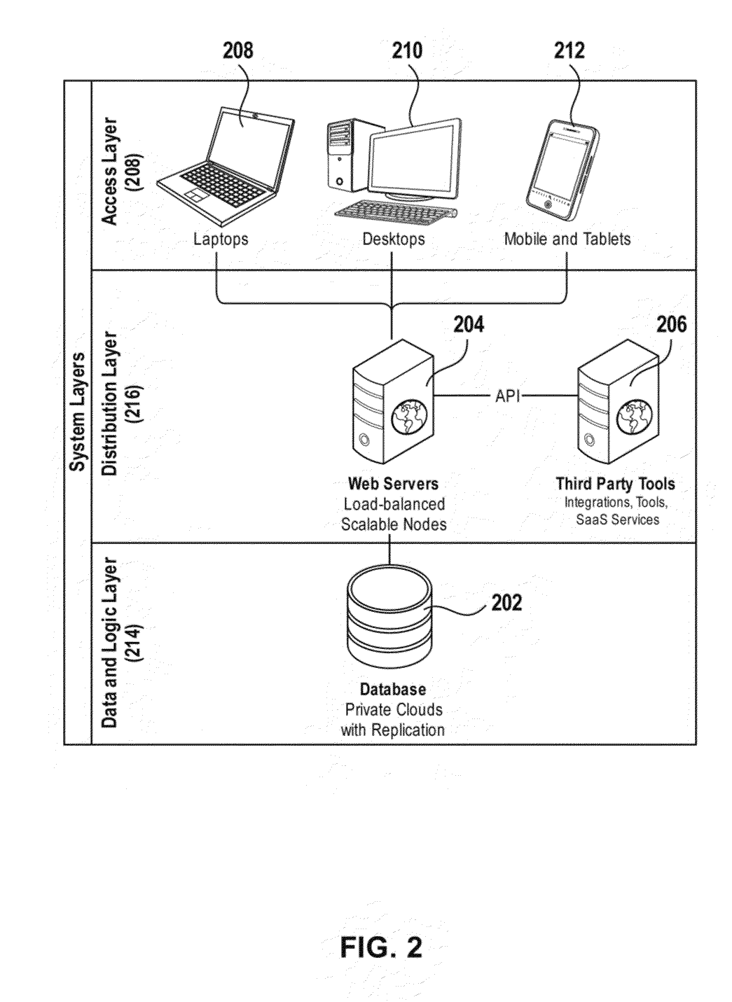

FIG. 2 illustrates the different system layers. At core there is the data and logic layer 214. This layer is comprised of a database 202. The database 202 may be a dedicated database server or a private cloud-based server with replication. The data and logic layer 214 is communicably connected to the distribution layer 216. The distribution layer is comprised of web servers 204 and third part tools 206. The web servers 204 can be comprised of load-balanced scalable notes and the third party tools can be comprised of integrations, tools and software as a service (SaaS) services. The access layer 216 is communicably connected the distribution layer 216. The access layer can be comprised of laptops 208, desktops 210 and portable electronic devices 212 to include mobile phones, tablets or various electronic devices suitable for access to a network such as the internet. These various devices listed in the access layer all comprise processors capable of performing the executable steps of the disclosed method. The Access layer 218 provides the ability for users, suppliers, licensees and support personnel to access the system 100.

Table 1 depicts the different capability based one embodiment of configuration of the system. The columns indicate the various value packages available for the system 100. The row indicates the various features available for the system. The information in the table indicates whether or not certain features are incorporated into the different value packages.

Table 2 depicts the different capability based one embodiment of configuration of the system. The columns indicate the various value packages available for the system 100. The row indicates the various permutations available for the system. The information in the table indicates whether or not certain permutations are incorporated into the different value packages or whether or not such permutations may become part of the various value packages.

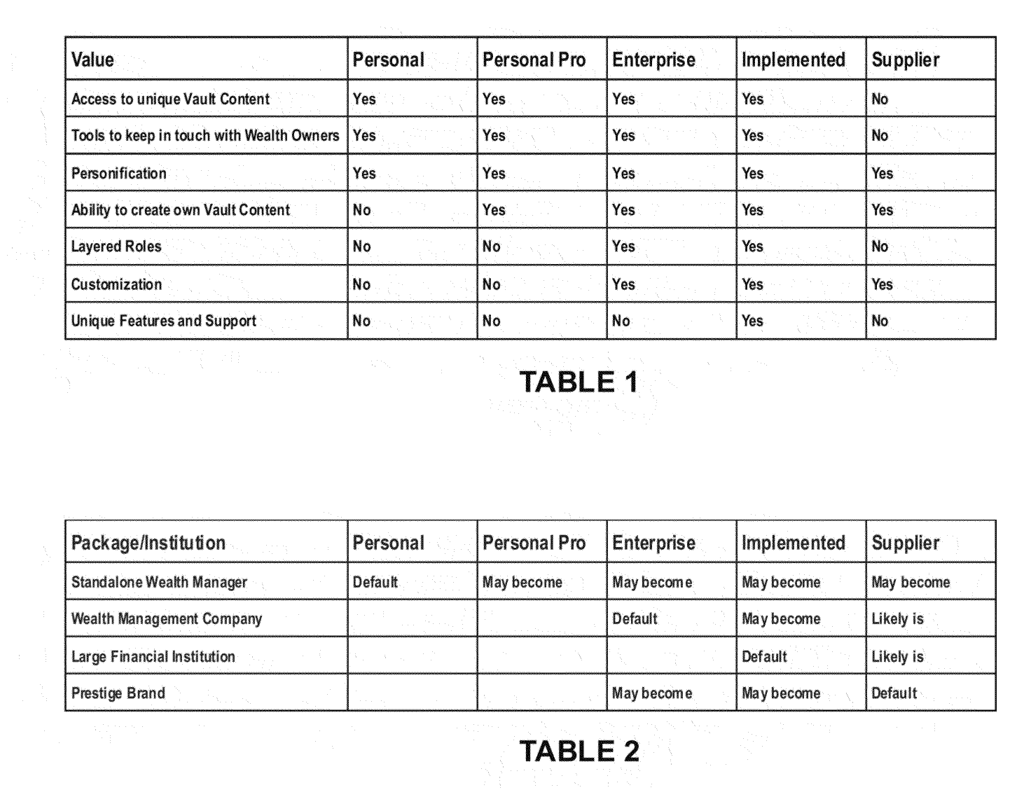

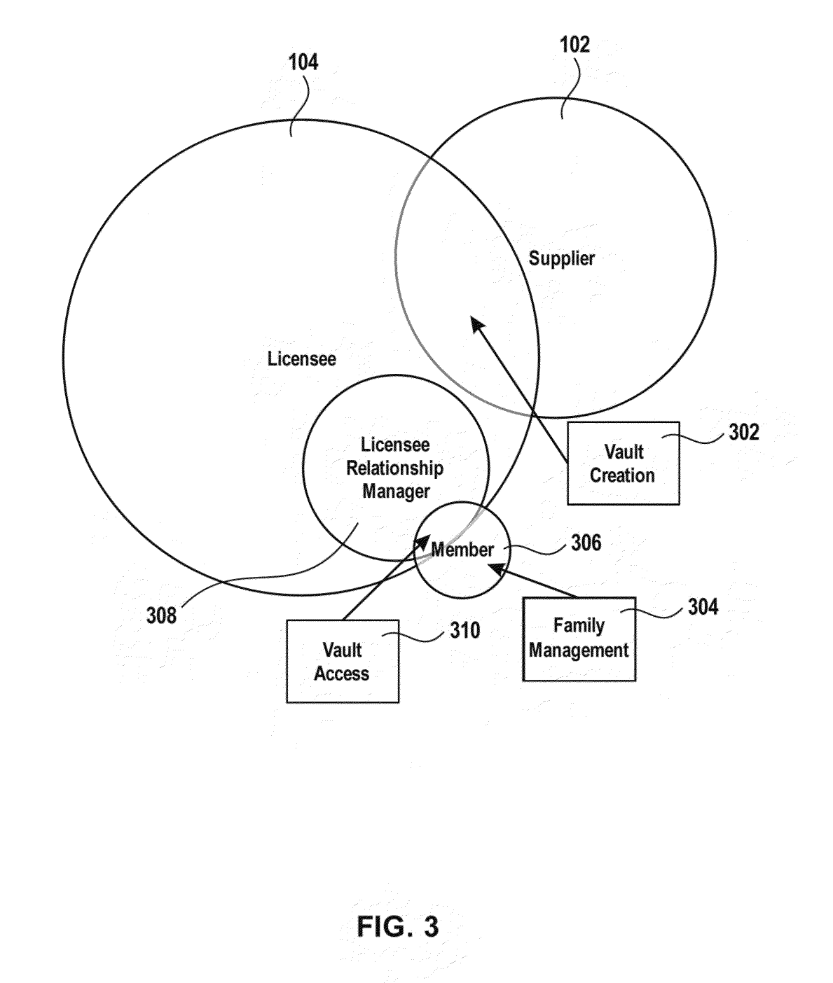

FIG. 3 illustrates the relationship between different modules of the disclosed system 100 and method 1200. In one embodiment of the system 100 licensees 104 interact with suppliers 102 through the vault 302 to present product offering to members 306 through vault access 310. The licensee relationship manager 308 works for the licensee 104 to manage the relationship with the member 306. The member 306 controls access to information regarding other family management 304 issues with regard to the disclosed system 100.

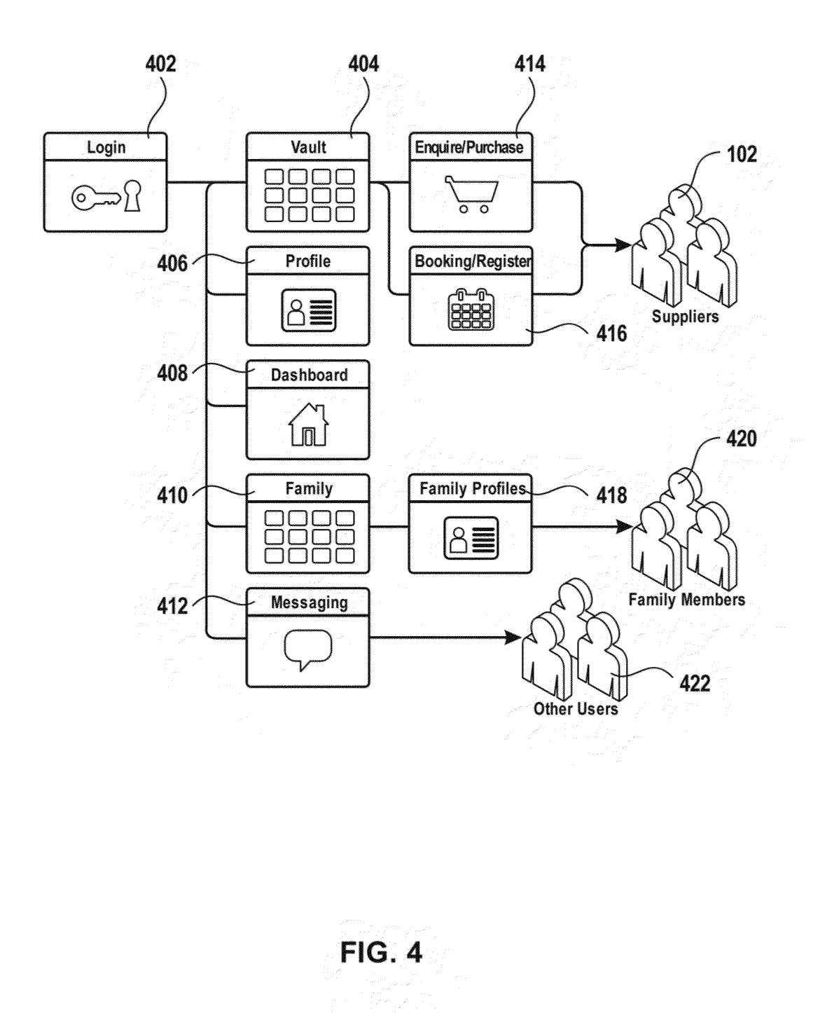

FIG. 4 illustrates one embodiment of the Member module 400. The login module 402 protects access to the system information through secure password entry. The default for the login module 402 is user name and password—the password is stored in one way encrypted method and the system has an extendable login module which allows us to put other methods in place (such as bank single login, pin, partial password or token). The vault module 404 allows members 306 (shown in FIG. 3) to view items for sale or event booking/registrar 416 on the vault 404. The vault module 404 is customized to the interests and preferences of the member 306 (shown in FIG. 3). For example, if the member 306 is interested in wine and watches, the events and products related to these preferences can be highlighted to the member 306, particularly in the “Selected for You” (or similarly titled) area of the Vault 404. The enquire/purchase module 414 provides all typical e-commerce features for the advertising, purchase and shipment of goods to the member 306 (shown in FIG. 3). The booking/register module 416 allows for the complete purchase or reservation process of different events by the member 306. The member profile 406 module allows the member 306 (shown in FIG. 3) or the relationship manager 308 (shown in FIG. 3) to add or edit information regarding the member to allow for better service by the relationship manager, such as occupation, hobbies and interests, dietary preferences, special dates or occasions, etc.

Member preferences can be matched using an algorithm that weights, allocates, and deallocates interests and considers one or more of the following: (1) interests that a member 306 selects themselves on his or her own profile; (2) the interests indicated by interaction of the member 306 with items within the system 100 such as items viewed, invites and suggestions sent to other members, items consumed, and items attended/rejected; (3) interests indicated by a client relationship manager 308 (shown in FIG. 3) within the system (derived by suggestions and invites sent to the member 306); (4) the interests indicated by a friends and family of a member 306 within the system (derived by suggestions and invites sent to the member 306); (5) interests indicated as similar to interests indicated or discovered above (derived by looking at members 306 within a demographic with similar interests and friend and family groups); (6) interests indicated as similar through keyword matching across item content; and (7) interests are stored as either self, suggested, or system derived.

Interests can be weighted and deallocated (other than self-indicated which would just be weighted down) based on lack of interaction, the current month (where historic data exists), the results of post-event surveys, and tier level.

The member preferences can then be used to match events with the same interests or, the same category of interests, and either: displayed as suggested events to the user themselves or; displayed as suggested invitees for an event to: the Client Relationship Manager who has this user as a Member/Client; the Luxury Brand (or other Prestige Organization) who has this user as a Member/Client (for the VIP offer); and the Member who is using the Vault with contacts.

The member dashboard module 408 allows the member or relationship manger to view all applicable system information (such as the history of interactions with the system content, invitations sent and RSVPs, events attended, feedback supplied on events or other offers, log of communications exchanged, notes, etc.) regarding the member in one convenient page. The family module 410 allows for a member 306 (shown in FIG. 3) or relationship manager 308 (shown in FIG. 3) to manage the family relationships of the member 306. Individual family profiles 418 can be built for a plurality of family members 420. The messaging module 412 allows members 302 to communicate with other system users 422. The messaging module can comprise of instant messaging, texts, private, secure email, or other similar electronic messaging systems.

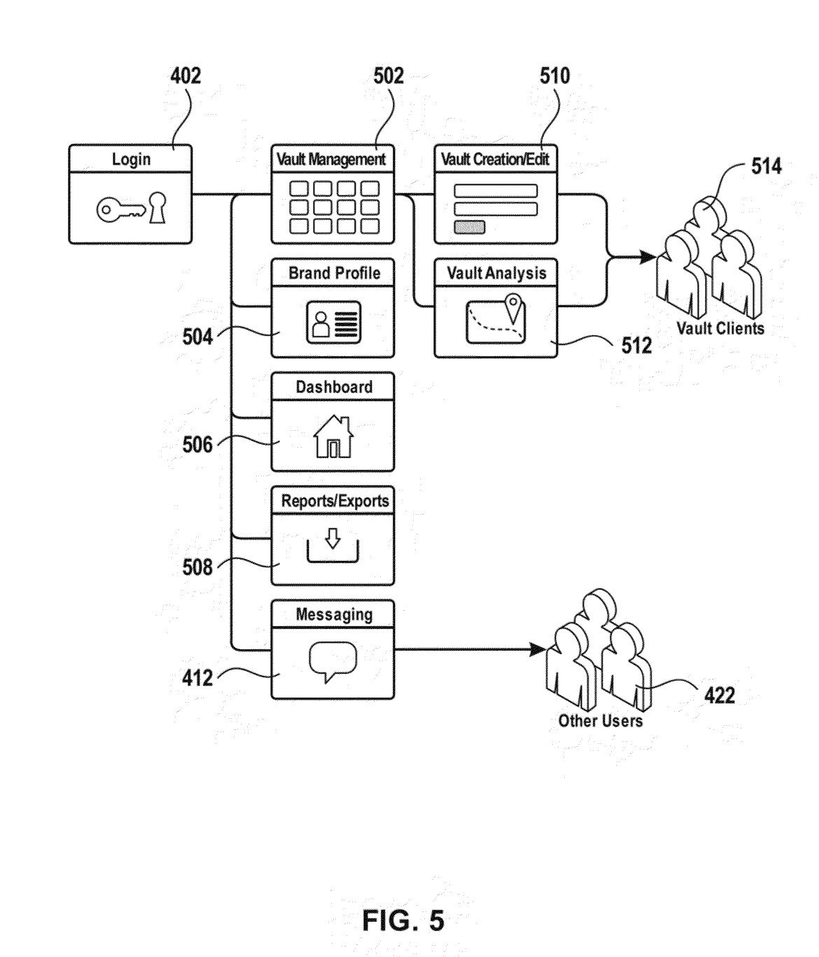

FIG. 5 illustrates one embodiment of the Supplier module 500. The login module 402 protects access to the system information through secure password entry and unique ID (may be email address and/or Supplier Internal Reference Number/ID). The vault management module 502 allows suppliers 102 to post and arrange various goods and services for sale or event booking/registrar 416 on the user's vault 404. The vault creation/edit module allows suppliers 102 to customize various vault profiles by adding/editing/removing various offers and promotions for different members 302. The vault analysis module 512 provides by analysis in the success of various promotions. The brand profile 504 module allows the supplier to add/edit/remove information regarding the brand to allow for better service by the relationship manager (such as tags that reflect type and nature of content, suitability of content for different ages or demographics, target audiences, location and format of content, other relevant qualities of the organizer or the content itself). The supplier dashboard module 506 allows the member or relationship manger to view all applicable system information (such as contact details, terms and conditions, other related offers, editorial or imagery, archive of past offers and option for selected feedback or testimonials, etc.) regarding the supplier in one convenient page. The reports/exports module 508 allows the supplier the capability to generate reports regarding the interactions with suppliers and licensees (such as numbers and demographic details of people who have attended events or purchased or redeemed offers, patterns of behavior, comparison of events and offers by different metrics, feedback received for one event or across a selection of events, costs of events/offers vs. revenues generated, etc.). The event/sale support tools 516 enable suppliers to easily manage the vault for various customers. It could be. Also on-the-day event management device may be developed within system (and with related hardware if needed) to scan Quick Response (QR) or bar codes to confirm and register attendance of expected guests. The messaging module 412 allows suppliers 102 to communicate with other system users 422. The messaging module can comprise of instant messaging, texts, private secure email, or other similar electronic messaging systems.

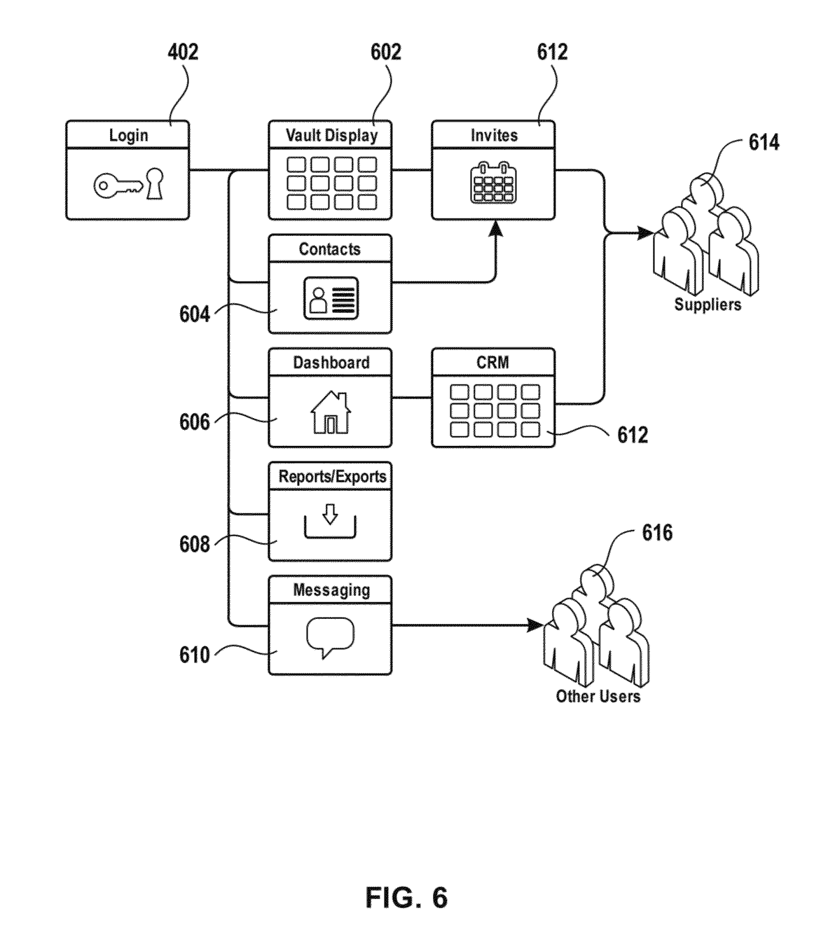

FIG. 6 illustrates one embodiment of the licensee relationship manager module (may also illustrate the licensee marketing manager module). The login module 402 protects access to the system information through secure password entry and unique ID (may be email address and/or Licensee Internal Reference Number/ID). The deployment module 602 allows relationship manager to manage selected information on client vault pages, such as targeted distribution of “Relationship Manager” events and “By Arrangement” events. The contact module 604 allows the relationship manager to view/add/edit contacts. The invite module 612 allows the relationship manager to invite others to become system clients. The users admin module allows the Licensee to add/edit/remove information regarding the clients and internal users (Relationship Managers and Marketing Managers) to allow for better service by the relationship manager. The relationship dashboard module 606 allows the internal user (e.g., relationship manager or marketing manager) to view all applicable system information regarding themself in one convenient page, such as their own contact details, preferred title, email signature, interests, etc. The Client Relationship Module 612 assists the relationship manager by displaying the shared personal details and other data expressly input by Members or inferred by the system's tracking of Member usage, as well as reserving areas for data entry or import that remains privately viewed by the Relationship Manager only. The reports/exports module 608 allows the relationship manager the capability to generate reports regarding the interactions with suppliers and licensees, such as member attendance, redemptions, activity, feedback. Also, on-the-day event management device may be developed within system (and with related hardware if needed) to scan Quick Response (QR) or bar codes to confirm and register attendance of expected guests, etc. The messaging module 412 allows members 302 to communicate with other system users 422.

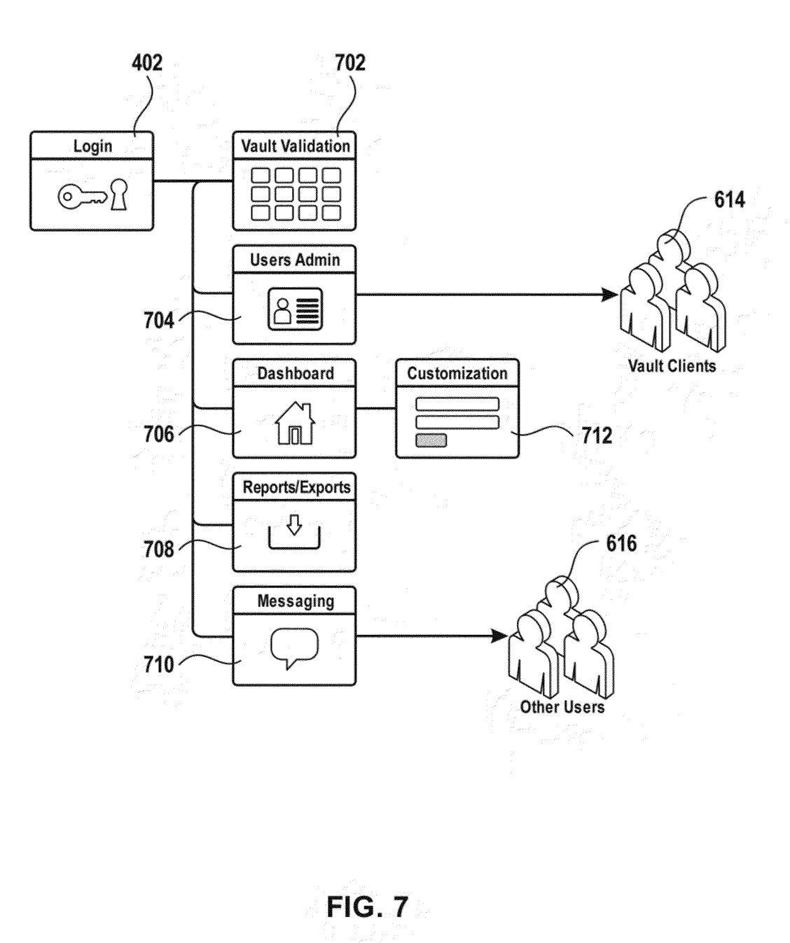

FIG. 7 illustrates one embodiment of the licensee admin module. The login module 402 protects access to the system information through secure password entry and unique ID (may be email address and/or Licensee Internal Reference Number/ID). The vault validation module 702 allows administrative staff to validate information on the vault pages, i.e., to accept, reject, or query Supplier content. The users admin module 704 allows the supplier to add/edit/remove information regarding the clients, users, and suppliers to properly manage the entire system. The admin dashboard module 706 allows the admin manger to view all applicable system information, such as user interactions with the system, account management, user details and profiles, tracking of item (offer/event) creation and history, additions of new vault content, etc. regarding the system in one convenient page. The customization module 712 allows the admin manager to customize the dashboard and interfaces with a Licensee's own branding, color palette and other design features, as well as select configurations of a range of system modules. The messaging module 710 allows admin managers 302 to communicate with other system users 616.

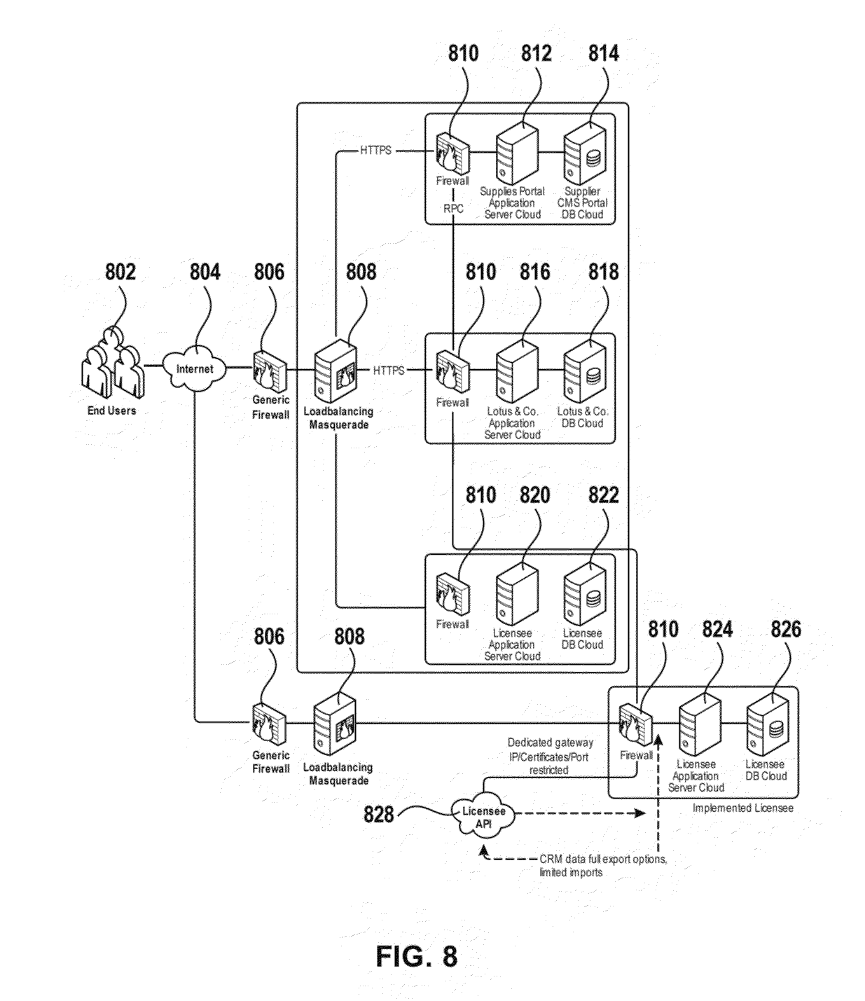

FIG. 8 illustrates the basic system architecture. The system 100 is comprised of a database (814, 818, 822, 826), application servers (812, 816, 820, 824), and finally portable electronic devices, desktop and laptop computers, tablets, and smart-phones in which users can access the system. The devices the users access the information and the database access the internet 804 to transfer and receive information. Firewalls (806, 810) on the user side and database side protect the system 100 and client information.

The system 100 is comprised of a client engagement database (814, 818, 822, 826). The databases (814, 818, 822, 826) are computer databases accessible via electronic communication which contains information on banks, clients, client preferences, relationship managers, Suppliers offers, and Licensee offers. The databases (814, 818, 822, 826) are periodically updated, e.g. daily or continuously, to include the most accurate, up-to-date information. In one embodiment, the databases (814, 818, 822, 826) used are indexed flat file databases. The databases (814, 818, 822, 826) are communicatively connected to database servers (812, 816, 820, 824) and may reside on the database server (812, 816, 820, 824) or on a separate computer and/or one or more separate database storage devices. The database servers (812, 816, 820, 824) host a database management system for managing the steps of writing and reading data to and from the database. The database servers (812, 816, 820, 824) control the flow of information to and from the databases (814, 818, 822, 826).

The database servers (812, 816, 820, 824) are communicatively connected to a web server (load balancing masquerade 808). The web server 808 hosts information, documents, scripts, and software needed to provide user interfaces and enable performance of methodologies in accordance with an exemplary embodiment of the system and method. By way of example and not limitation, the web server 808 may include web page information, documents and scripts (e.g. HyperText Markup Language (HTML) and Extensible Markup Language (XML)), applets, and application software, which enables users to access information contained in the database and display offers, or client information in response requests from users. The web server 808 connects the database server to the internet.

In one embodiment, access to the web server 808 is accomplished through use of a personal computer which is electronically connected to the internet. This connection may be through a wired or wireless local area network.

A plurality of users may access the web server 808 using compatible computing devices with network connectivity. By way of example, such devices may include personal computers, laptop computers, handheld computers, personal digital assistants, tablets, mobile phones or any compatibly equipped electronic computing devices. User computing systems may include an operating system and a browser or similar application software configured to properly process and display information, documents, software, applications, applets and scripts provided by the web server.

In one embodiment, access to the web server 808 is accomplished through use of a portable electronic device which electronically connects to the internet. The portable electronic device can electronically connect directly to the internet or be operably connected to a personal computer which connects to the internet.

In one embodiment, a user 802 may access the system through a portable electronic device through an application or through a personal computer through use of a web browser.

The users access the database and its client engagement database through an application programming interface (API) 828. An application programming interface is a protocol intended to be used as an interface by software components to communicate with each other.

The system is not limited to any particular network connectivity or communication protocol. Various forms of communication networks may be used by personal computers or portable electronic devices to access the web server 808. By way of example and not limitation, a proprietary Wide Area Network (WAN) or a public WAN, such as the Internet, may be used. These networks typically employ various protocols such as the HyperText Transfer Protocol (HTTP), File Transfer Protocol (FTP), Extensible Markup Language (XML), and Transfer Control Protocol/Internet Protocol (TCP/IP) to facilitate communication of information between communicatively coupled computers. The system may also utilize wireless networks, including those utilizing Global System for Mobile (GSM), Code Division Multiple Access (CDMA) or Time Division Multiple Access technology, and the Wireless Application Protocol (WAP). Furthermore, the system may utilize any, all, and any combination of such communications networks, as well as communications networks hereafter developed.

The computing devices described herein (e.g., personal computers, handheld computers, servers, portable electronic devices) may be comprised of commercially available computers, hardware and operating systems. The aforementioned computing devices are intended to represent a broad category of computer systems capable of functioning in accordance with the present invention. Of course, the computing devices may include various components, peripherals and software applications provided they are compatible and capable of performing functions in accordance with the present invention. The computing devices also include information, documents, data and files needed to provide functionality and enable performance of methodologies in accordance with an exemplary embodiment of the invention. The computers and electronic systems disclosed consist of processors which perform the electronic steps capable of performing the methods disclosed herein.

Firewalls (806, 810) may be located between web servers 808 and the database servers (812, 816, 820, 824) to protect against corruption, loss, or misuse of data. The firewalls (806, 810) limit access by the web servers 808 and prevents corruption of data. Thus, the web server 808 may be configured to update and receive data only to the extent necessary. The firewalls 808 may be comprised of any hardware and/or software suitably configured to provide limited or restricted access to the database server. The firewalls 808 may be integrated within the database servers (812, 816, 820, 824) or another system component, or may reside as a standalone component.

Functions and process steps described herein may be performed using programmed computer devices and related hardware, peripherals, equipment and networks. When programmed, the computing devices are configured to perform functions and carry out steps in accordance with principles of the invention. Such programming may comprise operating systems, software applications, software modules, scripts, files, data, digital signal processors (DSP), application-specific integrated circuit (ASIC), discrete gate logic, or other hardware, firmware, or any conventional programmable software, collectively referred to herein as a module.

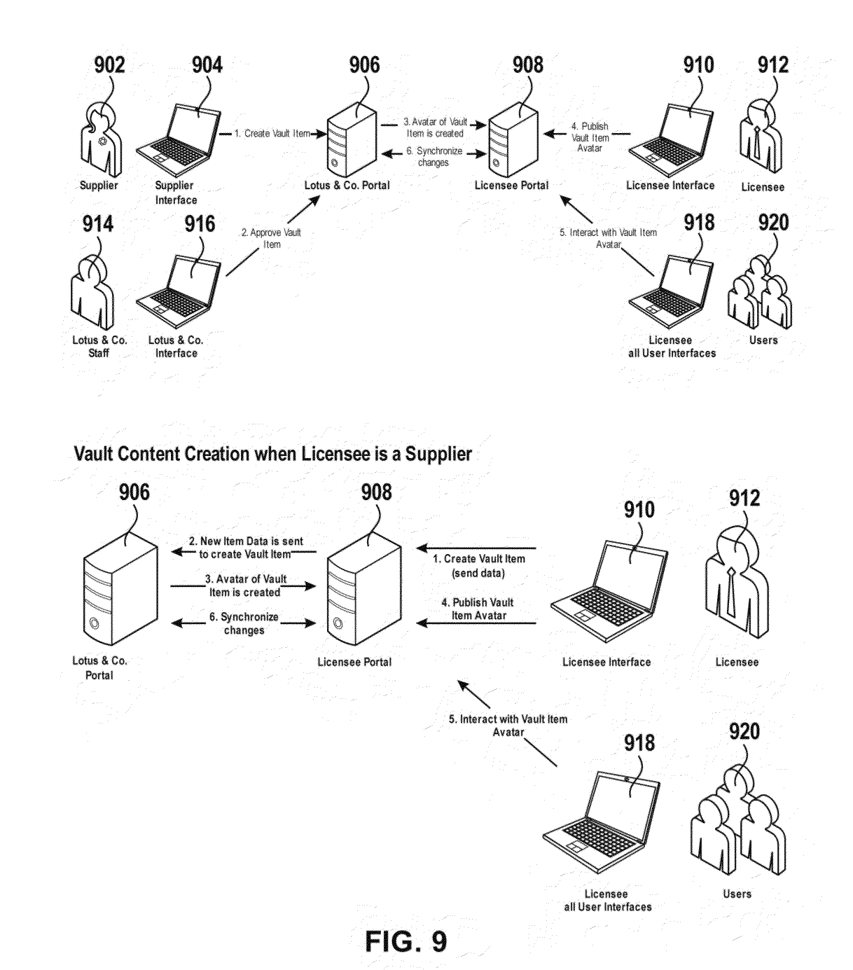

FIG. 9 depicts one embodiment of the system process flow for the disclosed system. Apprecie 914, through the applicable interface 916, create a new Supplier 902 (for example, Luxury Brands/Prestige Partners) account to access the database server 906 through the supplier interface 904. Next Suppliers 902 upload products, events and offers to the system database 906 to be displayed as selected/specified in the system vault. These offers remain posted for either a preset period of time, or are removed/paused by Suppliers 902 or system administrators 914. The system notifies corporate clients of Suppliers events/offers which have been added to the vault. Relationship Managers 912 create accounts through the licensee interface 910 and assign their clients 920 in the system. The system 100 allows the clients 920 to access the system and view all or targeted offers in the vault. Clients 920 can book, select, purchase, and claim offers from the vault directly through the Vault page and/or subsequent associated messaging and communications through a user interface 918.

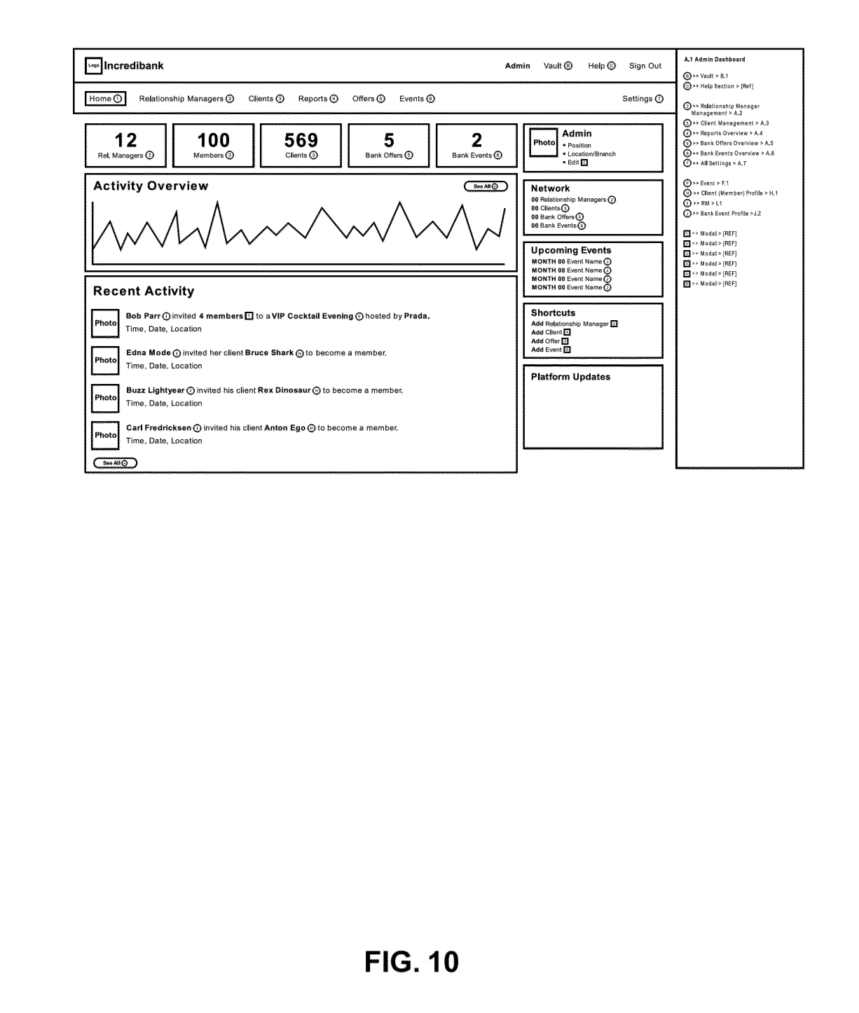

FIG. 10 depicts one version of the admin dashboard for a Licensee (the user interface can be customized for given License levels). This dashboard depicts a summary of client engagement activity for that Licensee on one page. In one embodiment, the page depicts number of relationship managers, members, clients, Licensee offers and Licensee events. In one embodiment, the page may display the overall system activity and recent client, member, or relationship manager activity. This page may be customized based on the Licensee's individual preferences and needs in managing its clients.

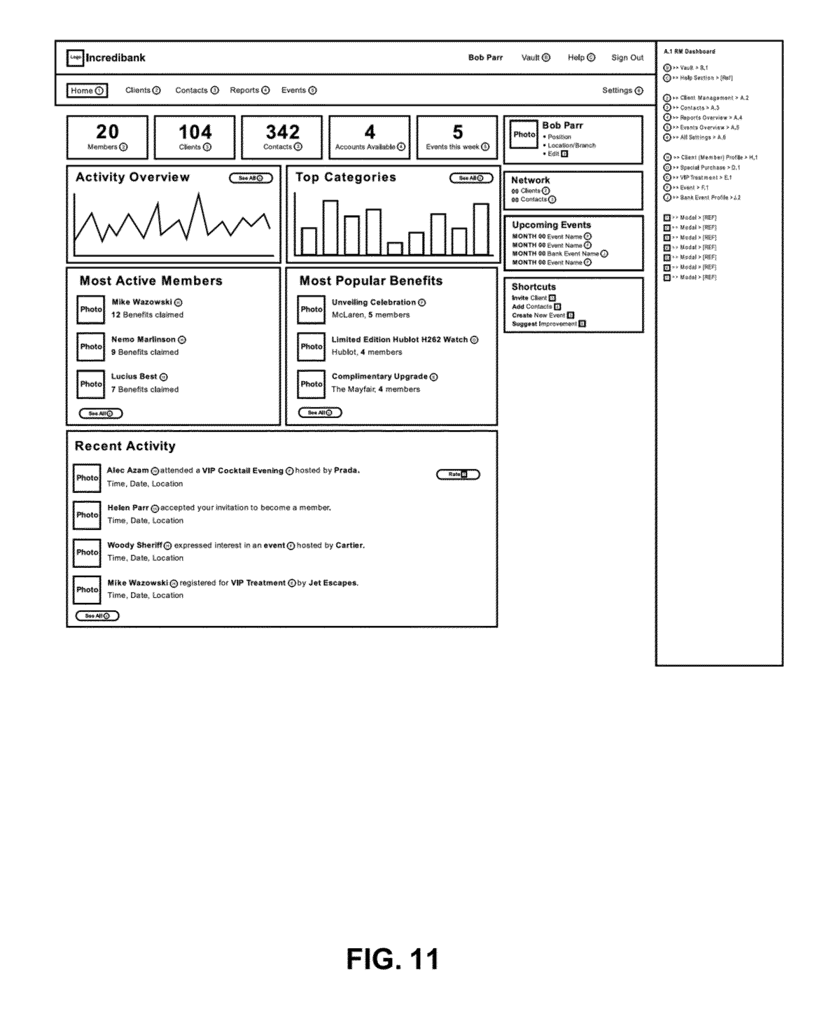

FIG. 11 depicts one version of the relationship manager dashboard (the user interface can be customized for given License levels). This dashboard depicts a summary of client engagement activity for that relationship manager on one page. In one embodiment, the page depicts number of members, contacts, clients, accounts available, and events. In one embodiment, the page may display the overall system activity, top categories, most active members, most popular benefits and recent client activity. This page may be customized based on the relationship manager's individual preferences and needs in managing his or her clients.

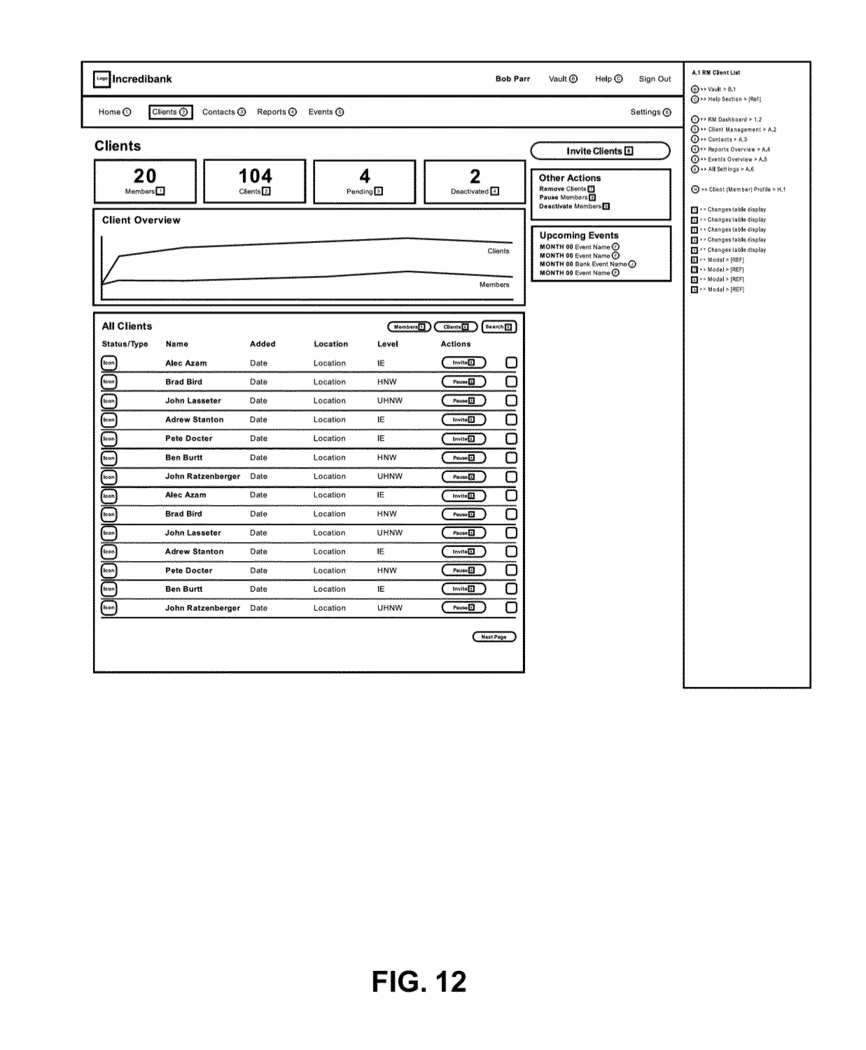

FIG. 12 depicts an illustration of a Relationship Manager client list. This dashboard depicts a summary of client activity for that Relationship Manager on one page. In one embodiment, the page depicts number of members, clients, pending clients, and deactivated clients. In one embodiment, the page may display the overall number of clients and members, and a sortable list of client information. This page may be customized based on the relationship manager's individual preferences and needs in managing his or her clients.

The Relationship Manager (RM) interface supports client retention through the provision of services not provided by the organization of the relationship manager but by being able to directly purchase services from other providers on behalf of their clients. This forms part of a clear retention strategy that allows the relationship manager to clearly track and evidence the value of either gifts provided to their Client or, the cost of Engagement for a particular Client.

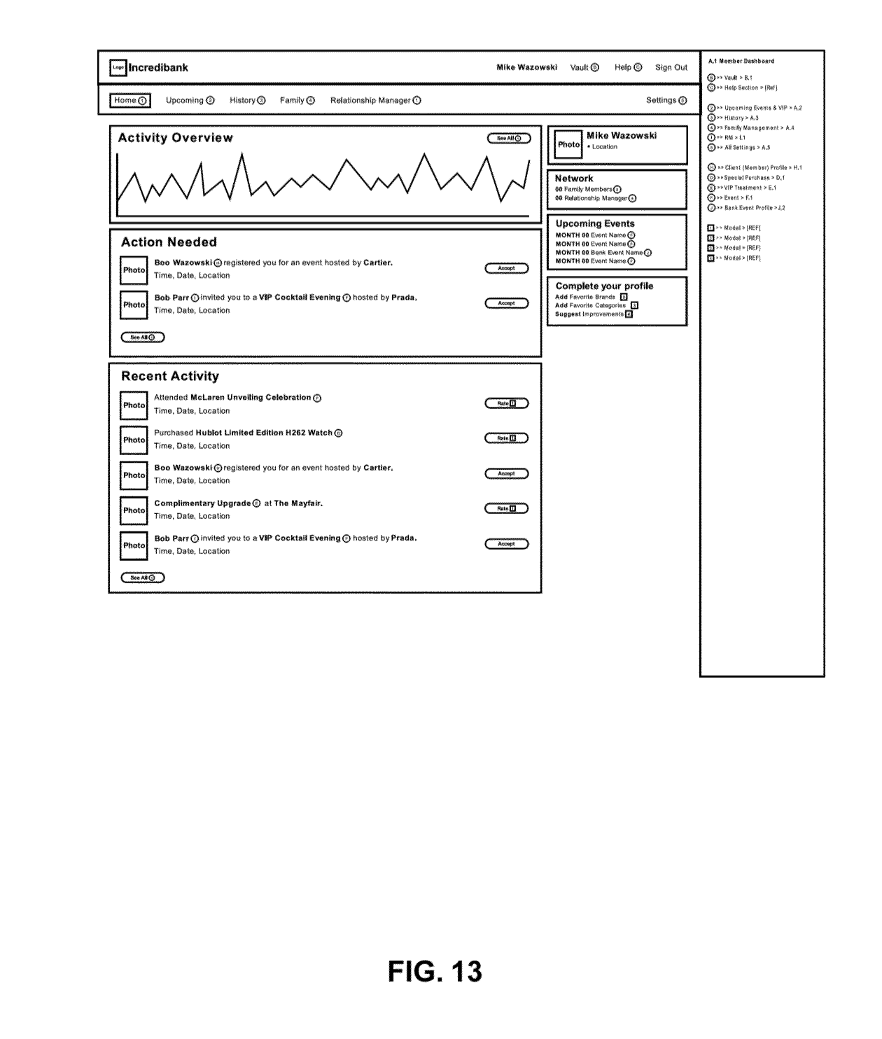

FIG. 13 depicts one embodiment of the Member dashboard (the user interface can be customized for given License levels). This dashboard depicts a summary of member activity, overall activity and actions requiring input. In one embodiment, the page depicts the overall activity, the actions needs for clients, and recent activity by clients. This page may be customized based on the member's individual preferences.

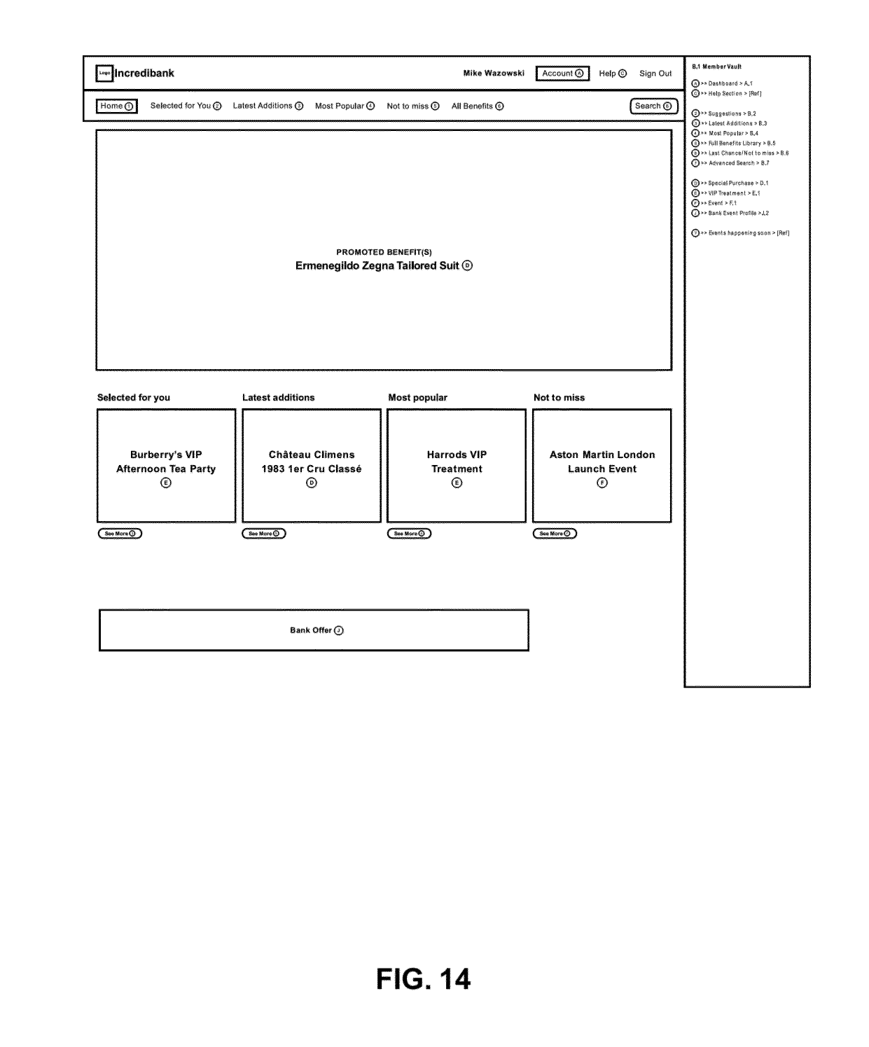

FIG. 14 depicts one embodiment of the member vault dashboard (the user interface can be customized for given License levels). In one embodiment, it displays various offers to clients, in various active display boxes which can be selected by clients. The system tailors each vault dashboard based on the systems information about the client to best suit that client's tastes and needs. Licensee offers may also be displayed on this page. This page may be customized based on the relationship manager's individual preferences and needs in managing his or her clients. The Vaults are populated by offers from Suppliers (prestige partners and other organizations including arts & culture organizations such as museums, orchestras, heritage & conservation groups, etc.). These unique offers are not generally publicly available, but only to the members of the disclosed system or other exclusive groups. Vaults are dynamically configured based on a member's specific interest. This creates unique customer intimacy and knowledge to allow the companies providing the service to better manage their clients and improve the relationship with their clients. The system performs extensive reporting functions to include areas of customer interest, brand loyalty, offers accepted, etc.

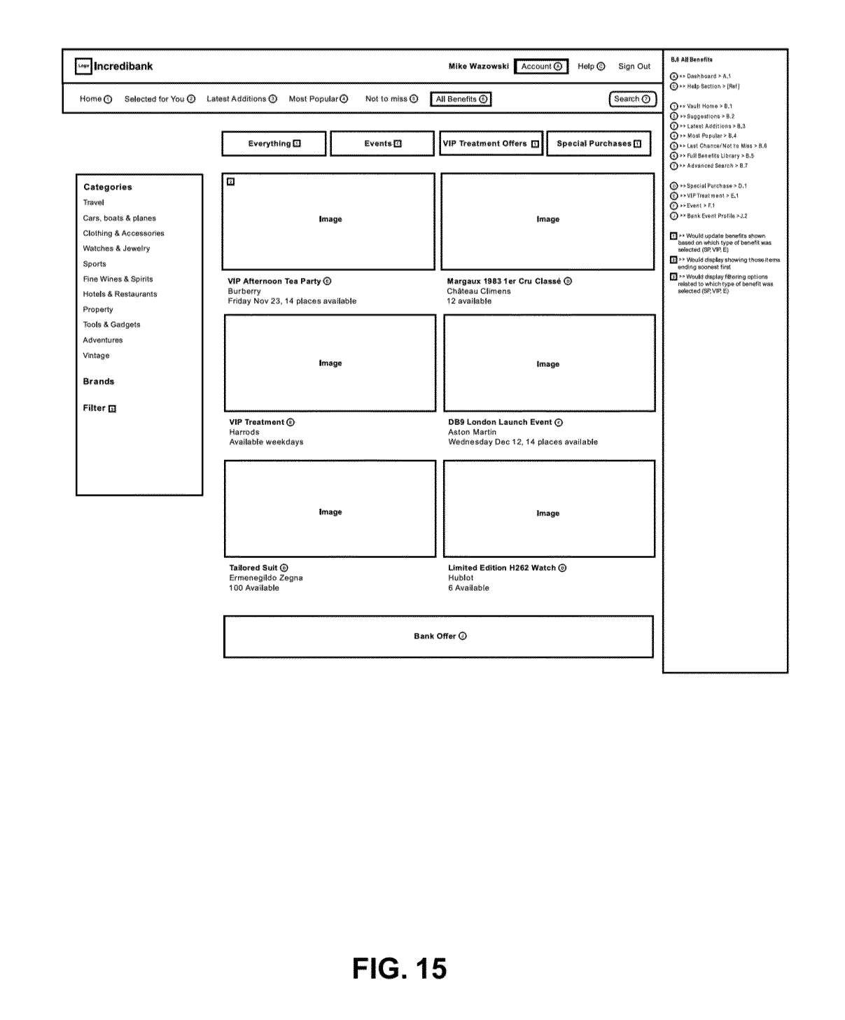

FIG. 15 depicts one embodiment of the Vault benefits display in which Suppliers (e.g., Luxury Brands/Prestige Partners) may advertise their products to all members or tagged/tiered members. In one embodiment, exclusive services, events, products and promotions may be displayed on this page for the benefit of the members. This page may be customized by the Licensee depending on their type of License Plan, and also reflects only the various offers and events as the system administrator approves. The brands, services, and events offered in FIG. 8 are Illustrative categories only.

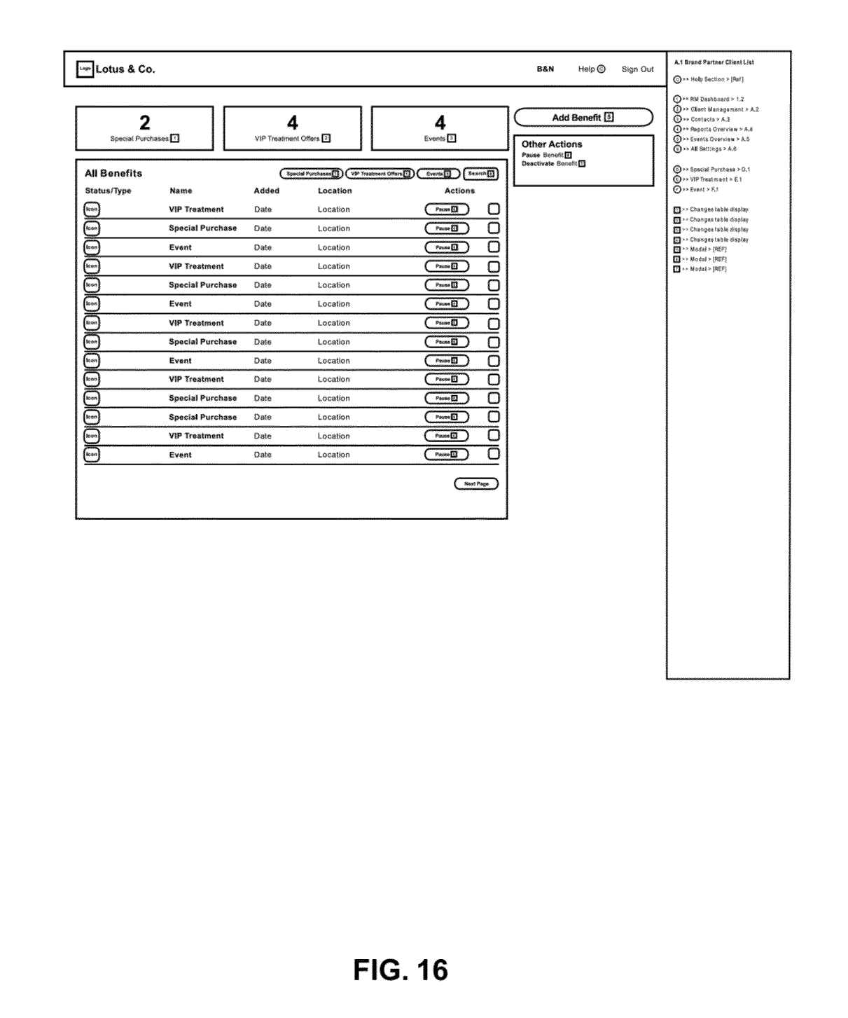

FIG. 16 depicts one embodiment of the Partner offer list. In one embodiment, the page depicts all the special purchases, VIP treatment offers, and events being offered by the Suppliers. The list may be sorted by the Supplier, and they may activate and deactivate offers from this page.

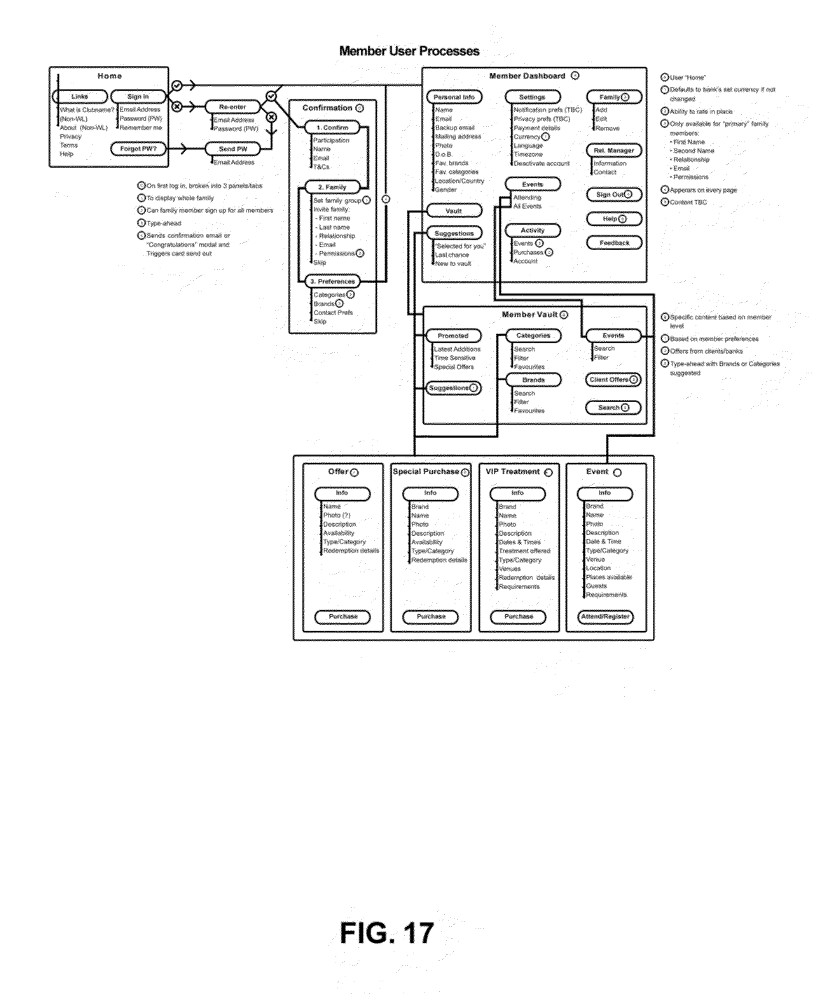

FIG. 17 depicts the flow chart for member user processes. The diagram depicts the type of user information entered and stored on the system. The diagram further depicts how the member dashboard is built and the type of offers, special purchase, VIP treatments and events for that client specifically tailored to that member's profile information.

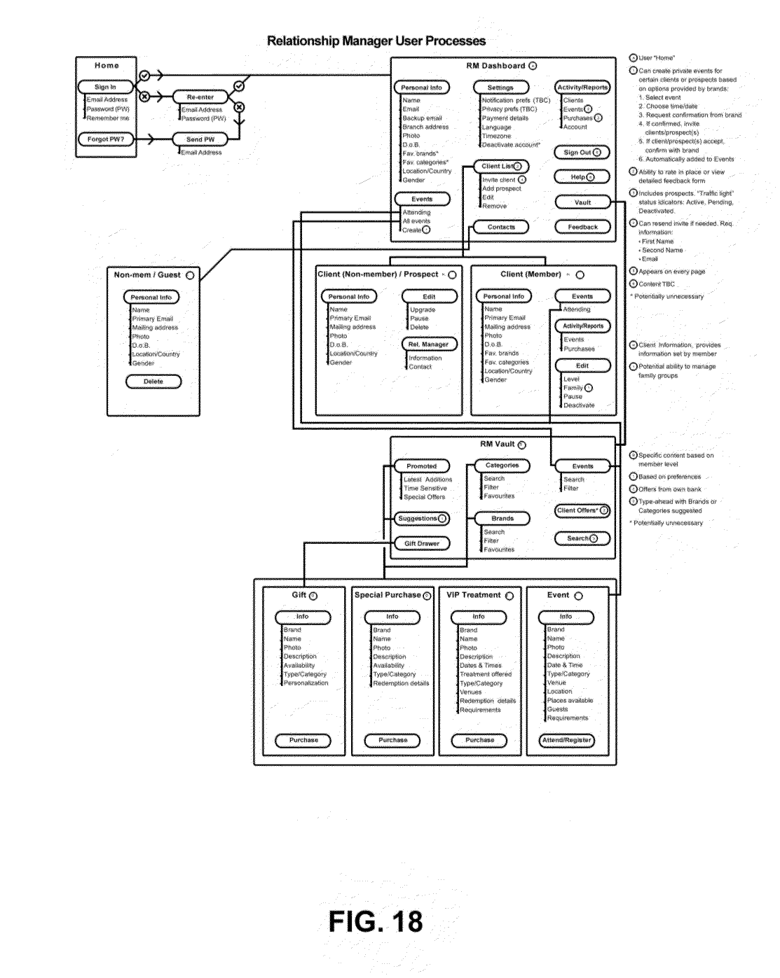

FIG. 18 illustrates relationship manager user process. The diagram depicts the type of information displayed on the relationship or marketing manager dashboard prospective client and client member information, relationship manager's vault offers, gifts, special purchases, VIP treatments and events. New Licensees are provided with the functionality to invite Members to sign up to the service and allow these Members to then take up offers published. The Marketing Manager Vaults include “Marketing Manager Selections” and the Relationship Manager Vaults include “Relationship Manager Selections”—offers only available to marketing or relationship managers, respectively, either for use with clients/prospects or by themselves. (The naming of this filtered vault content may be customized by Licensees.) Using the platform, relationship managers can populate preferences and interests for Non-member Contacts and Members to better serve their clients and clients' families, and to attract new clients more effectively.

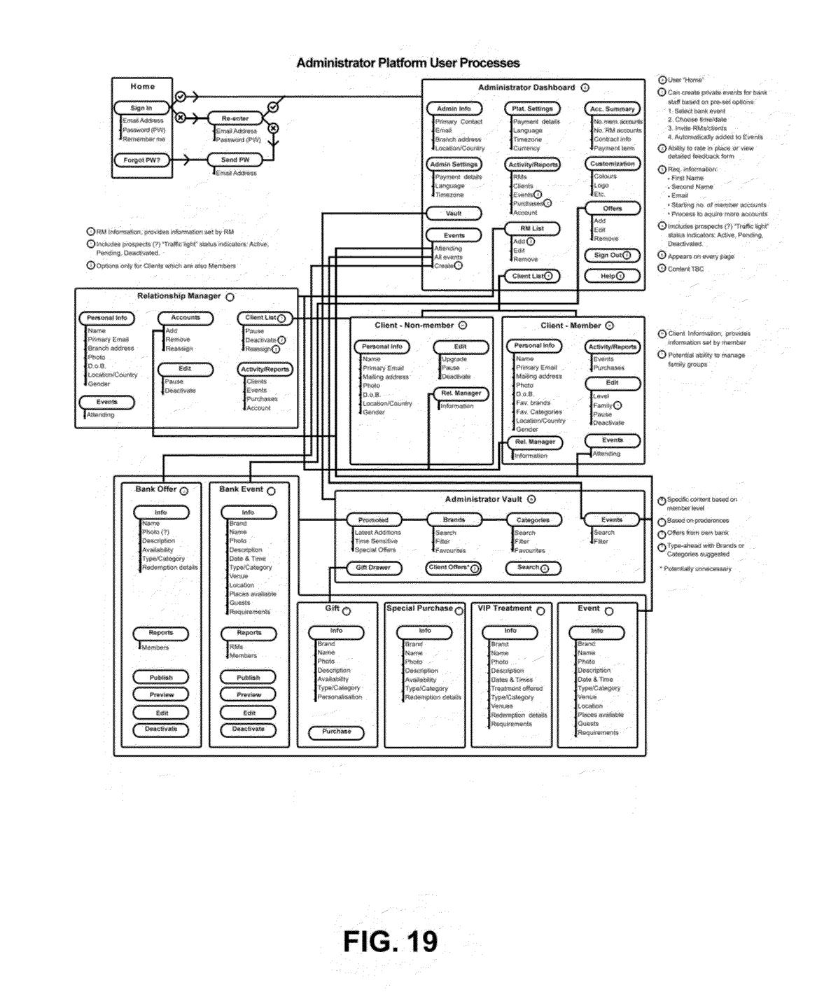

FIG. 19 illustrates the platform administrator user process. The diagram depicts the type of information displayed on the administrator dashboard, the relationship manager dashboard, the administrator vault, own offers, own events, and all other offers being promoted on their portal, e.g., gifts, special purchases, VIP treatments, events, etc. Using the administrator platform managers can populate preferences, interests and other demographic information for their internal or external users, in order to enhance the client experience and the productivity of business development activities.

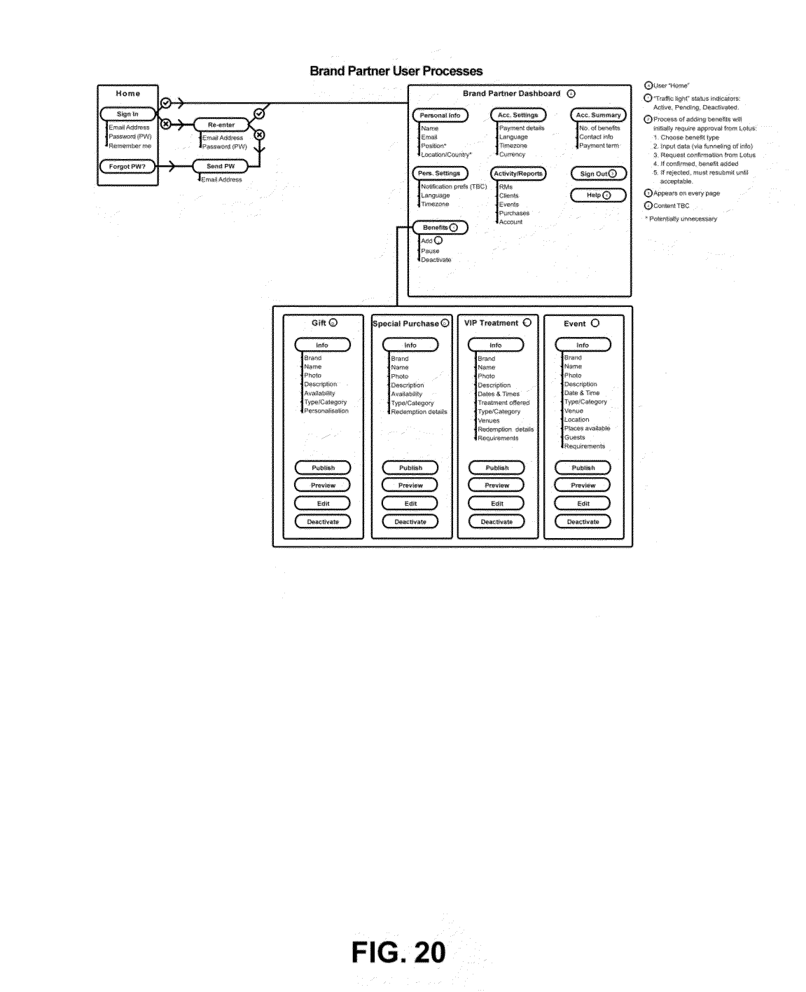

FIG. 20 depicts the Supplier user processes. The diagram depicts the Suppliers' dashboard, and the editorial content and offers (egg gifts, special purchases, VIP treatment and events) specific to that partner.

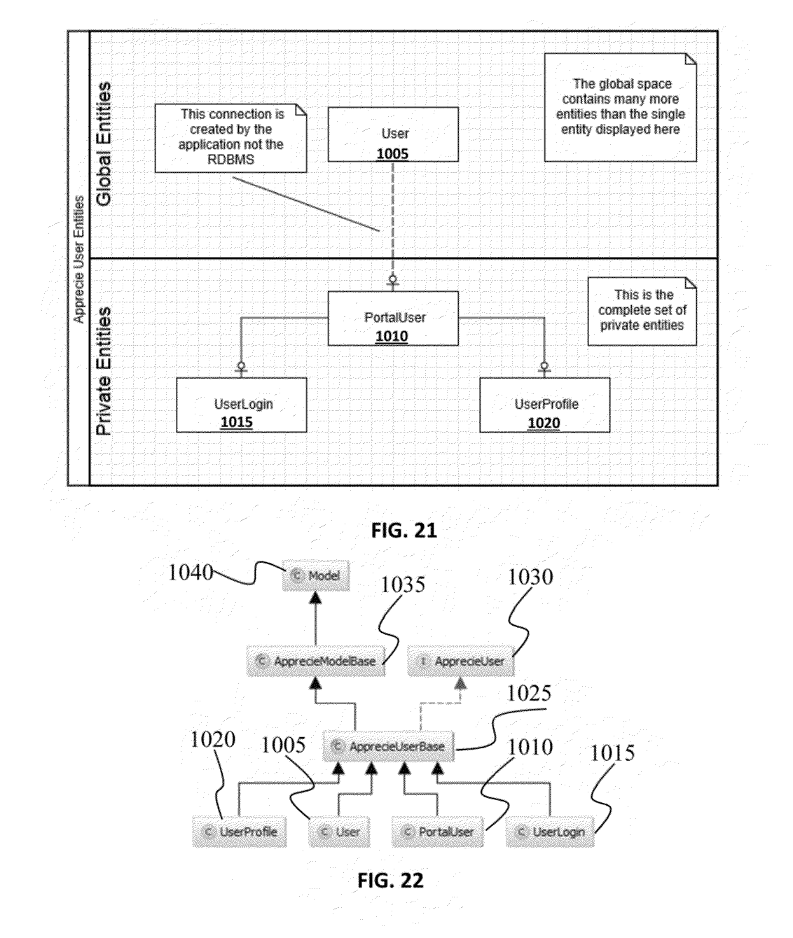

FIG. 21 illustrates one embodiment of the data isolation entities. Entities in the disclosed system 100 can be one of four separate types of entities. An entity is a group of related information. One of these entities, the user entity 1005, can be stored in the global database, and can be accessible by all portals. The user entity 1005 can be as simple as a series of alpha-numeric characters used to identify a client and contains no personal data. The user entity 1005 contains a globally unique identifier (Guid), a userid, and details of the portal (server) that the user entity 1005 is stored on. The globally unique identifier is used to uniquely identify information. This record is used in interaction within the global space, including cross portal interactions such as consumption and communication. FIG. 21 shows how the Entities for a user are related. For a user to be fully described, the system 100 pulls together information from each of the User Entities (User 1005, UserLogin 1015, PortalUser 1015, and UserProfile 1020). The ‘User’ information that is stored as a ‘Global Entity’ has no Personal, Sensitive or Valuable information associated with it—this is all held in the ‘Private Entities’. User 1005 is the record that defines each individual that exists on the system 100; UserLogin 1015 is the record that holds the Login details for a user; PortalUser 1010 is the record that holds portal specific details for the user, for example, the vault items that they have access to; UserProfile 1020 are the records that hold the personal and preference information about a user. A portal is a group of related users on a system (e.g., a group of entities that all work for the same corporate entity). All personal data, and by virtue the other three user entities (Portal User 1010, User Login 1015, and User Profile 1020) are stored under a per portal isolation scheme. The actual physical location of these tables could be in the same database, in a separate database, or even in a separate server in a different geographic location.

The connection to these private tables is handled in the application by the Object Relational Mapping (ORM) and the join is not traversable in the database(s). The models are injected with the isolated data source on hydration. This means that it is impossible for one portal to access another portal's users. Also only one isolated container can be connected at any time, and the isolated container being connected to can be based on the actions available to a user with appropriate permissions.

The connection between the User 1005 and the PortalUser 1010 is created by the application and not the Relational Database Management System (RDMS). RDMS is a management system for storing related information in a way that it can be easily retrieved and interrogated.

FIG. 22 shows the Interfaces that have been created to support the Entities. The ApprecieUserBase 1025 exposes all details that need to be used by an internal ApprecieUser 1030, the ApprecieModelBase 1035 and Model 1040 are Interfaces that provide subsets of this information that are exposed to Portal Users 1010. FIG. 22 further illustrates a simplified embodiment of data isolation system. As depicted in FIG. 22, all four user entities support the ApprecieUser interface, and extend ApprecieUserBase, to assist in navigating between these entities, in principle allowing each entity access to the related entities for the same user. However for the dynamic connection to operate between these entities the correct container must have been connected to as specified by the action taken by a user with appropriate permissions.

The dynamic container connection prevents the mixing of users from different portals. The following therefore describes the approach that can be taken in switching between portals showing there is no possibility within one portal to inadvertently access user details from another portal unless the association has been explicitly granted.

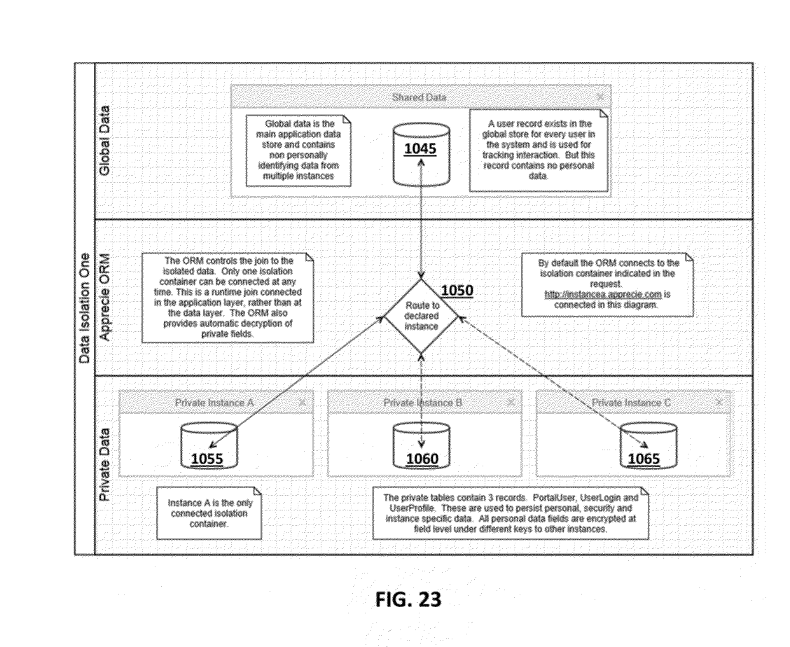

FIG. 23 illustrates a portion of the data isolation process. The system stores and processes three categories of information Global Data 1045, Apprecie ORM 1050, and Private Data 1055, 1060, and 1065. The first category is Global Data 1045. Global Data 1045 is the main application data store and contains non-personally identifying data from multiple instances. The ORM will pull together the appropriate information from Global and Private data into the correct format (unencrypted) so it can be read within a given Portal. A user record can exist in the global store for every user in the system. The user record can be used for tracking interaction. The user record contains no personal data.

The next category of information is Object Relational Mapping (ORM) information 1050. The ORM information controls the join to the isolated data. This is a runtime join connected in the application layer, rather than at the data layer. The ORM also provides automatic decryption of private fields. By default, the ORM connects to the isolation container indicated in the request.

The next category of data is private data. The private data can be isolated from the other records. FIG. 23 shows three instances (Private Instance A 1055, Private Instance B 1060, and Private Instance C 1060). The private tables can contain three records (PortalUser 1010, UserLogin 1015, and UserProfile 1020). The private tables can be used to store personal, security, and instance specific data in the database so it can be retrieved at a later date unless it has been explicitly removed. All personal data fields are encrypted at field level under different keys to other specific databases. Private data can be stored in different instances/databases for different Portals. As shown in FIG. 23, Private Instance A is the only connected isolation container. Once the system provides the instruction to switch the isolation container (by an explicit authorized user action) the active portals user entities will no longer connect, but the user entities of the selected new portal will.

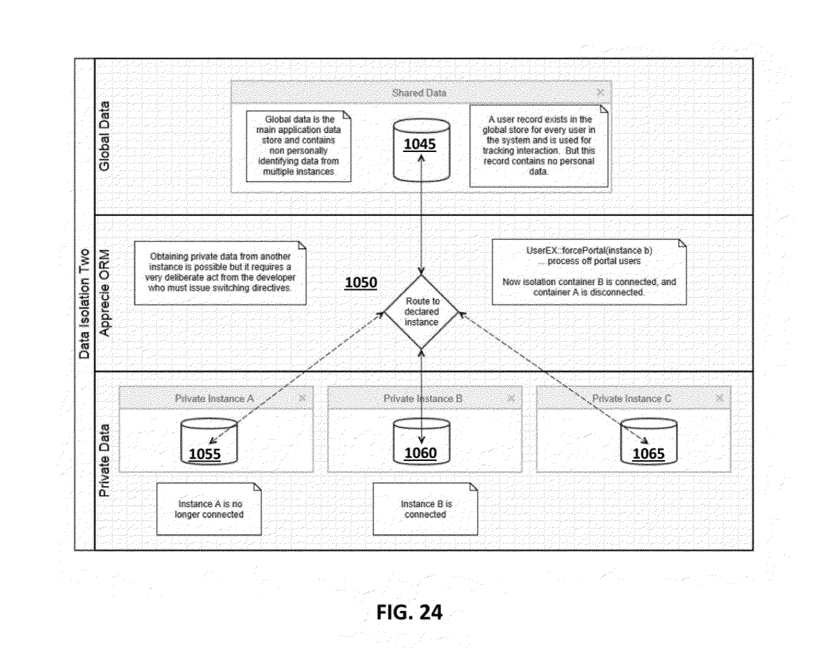

FIG. 24 is an exemplary drawing illustrating another data isolation condition where private data is obtained from private instance B 1060. FIG. 24 illustrates the condition wherein isolation container B 1060 is connected and container A 1055 is disconnected.

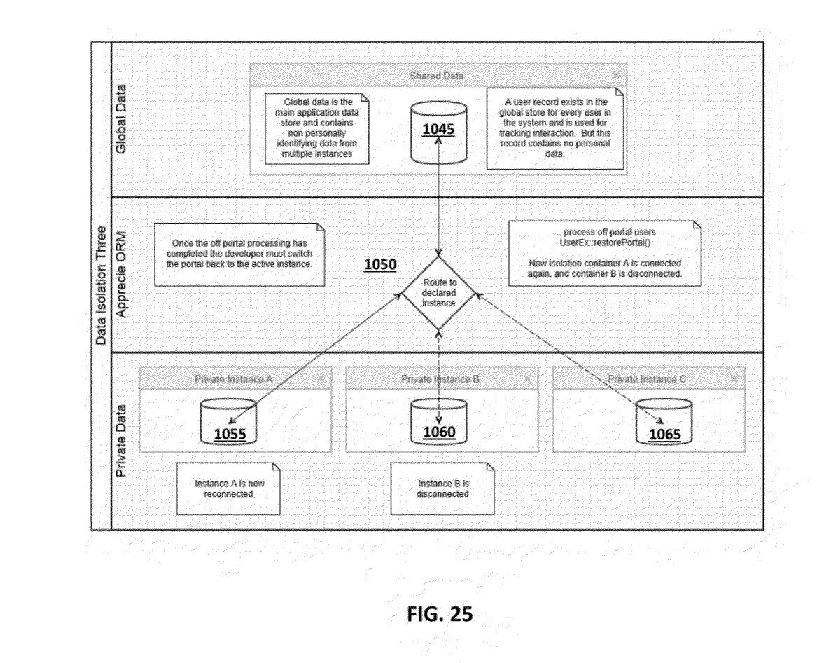

FIG. 25 is an exemplary drawing illustrating another data isolation condition where private data is again obtained from private instance A 1055. As shown in FIG. 25, isolation container A 1055 is connected again, and container B 1060 is disconnected.

Using the indicated directives it is possible to have multiple collections in memory from different isolation containers. However whenever one of the ApprecieUserBase entities attempts to traverse the dynamic join, if the portal is currently connected to the wrong isolation container for that user, then an exception is thrown and execution halts indicting than an illegal request has been made.

Each portal in the disclosed application is a private members only web application, accessible only over encrypted SSL connections, with private data isolation. Database files are encrypted on the file system, and all application and database communication is also encrypted. No internet access is available to any of the database servers, and they are hosted on private networks accessible only to key personnel through a two factor certificated VPN connection. The system operates with a global relational data store recording interactions and shared data, whilst all member profiles and personal details are stored in isolated per portal private tables. Within a database, private per portal data tables employ additional field level encryption on especially sensitive (identifying data) fields using a two factor key with at least one factor being totally unique to that instance. Messages and notifications follow a similar encryption scheme but with the second factor of the key on the user level. All backups are encrypted in transit and at rest.

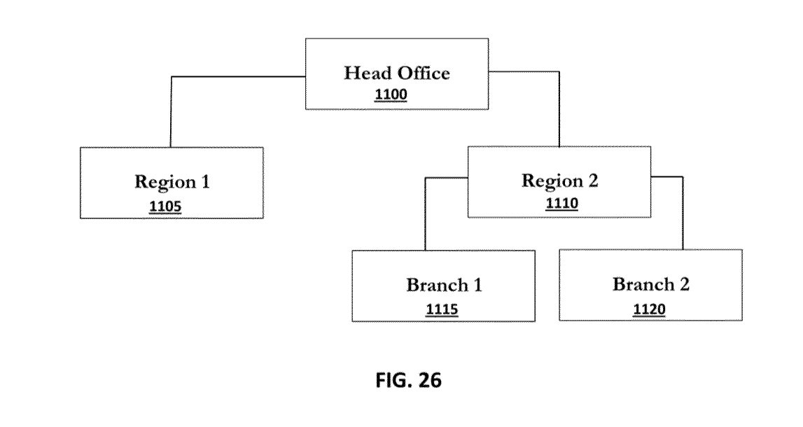

FIG. 26 is an exemplary line drawing illustrating the relationship of information across organizational hierarchies. The disclosed portals support a more complex relationship than the traditional client-supplier or tiered client-partner-supplier relationships. The structure is multi-facetted, configurable, and supports: Individuals or Groups of Relationship Managers can work with both many Clients and many Suppliers and support the delivery of services from any of the suppliers to any of their clients. All clients can be segregated into multiple Groups allowing for targeted activity to each of these groups.

At the most complex level, the system also supports an Organizational hierarchy allowing an organization to define separate Divisions and Sub-divisions where there is no limit to the depth of the hierarchy. Each of these Divisions can have relationships with their own exclusive list of Clients and Suppliers but, Clients can be shared up the hierarchy while Suppliers can be shared across the hierarchy.

For example, referring to FIG. 26, Client A, belonging to Region 1 can either be retained exclusively by Region 1, at 1105, or can be shared by Region 1, at 1105, Region 2, at 1110, and Head Office, at 1100. Supplier B, belonging to Region 2, at 1110, can be shared across Branch 1, at 1115, and Branch 2, at 1120, if Region 2, at 1110, allows it. If Supplier B was to be shared by both Region 1, at 1105, and Region 2, at 1110, Supplier B would need to belong to Head Office, at 1100.

Once a User has access to Client Data and Supplier Services, the approach to consuming services again has a multi layered approach. There are two primary services that can be Purchased and Consumed, ‘Confirmed Events’ and ‘By Arrangement Events’. ‘Confirmed Events’ are services that can be purchased directly. ‘By Arrangement Events’ require an interaction between the Purchaser and the Supplier to determine the details of the Event to be purchased. Once the details of a ‘By Arrangement Event’ have been agreed, a specific ‘Confirmed Event’ can be created and purchased.

The Purchaser of a ‘Confirmed Event’ will be either a Client directly or, more usually, a Relationship Manager purchasing a Confirmed Event on behalf of their Clients. Once Purchased, the attendees can be Invited to the Confirmed Event and their Acceptance/Rejection managed either by a response to an email or manually by the Relationship Manager. This differs from traditional Client/Supplier Relationships as it is a mediated transaction by the Relationship Manager, who manages the Event to completion and attendance after an event has been purchased. Traditionally, the delivery of a service is through a direct client/supplier interaction with only automated interaction or enablement from a third party platform.

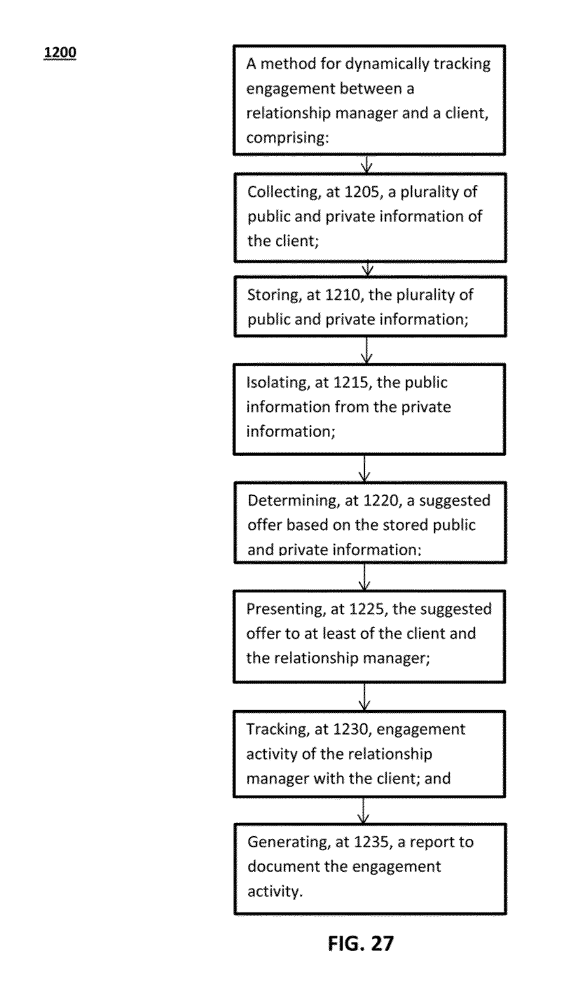

FIG. 27 is an exemplary flow diagram illustrating an embodiment of a method 1200 for dynamically tracking engagement between a relationship manager and a client. The method comprises collecting, at 1205, a plurality of public and private information of a client, storing, at 1210, the plurality of public and private information; isolating, at 1215, the public information from the private information; determining, at 1220, a suggested offer based on the stored public and private information; presenting, at 1225, the suggested offer to at least one of the client and the relationship manager; tracking, at 1230, engagement activity of a relationship manager with the client; and generating, at 1235, a report to document the engagement activity.

In one embodiment of the method 1200, the private information includes the preferences and interests of the client. In one embodiment, the method 1200 further comprises comprising presenting a suggested client for an offer to the relationship manager.

In one embodiment of the method 1200, the offer comprises a luxury good. In one embodiment of the method 1200, the offer comprises access to a Prestige Organization. In one embodiment of the method 1200, the offer comprises access to a co-sponsored event. In one embodiment of the method 1200, the offer comprises an event ticket. In one embodiment of the method 1200, the offer comprises an invitation for a special engagement. In one embodiment of the method 1200, the offer comprises an experience. In one embodiment of the method 1200, the offer comprises privileged access. In one embodiment of the method 1200, the offer comprises a privileged access to special arrangements relating to products, experiences or dedicated VIP client personnel.

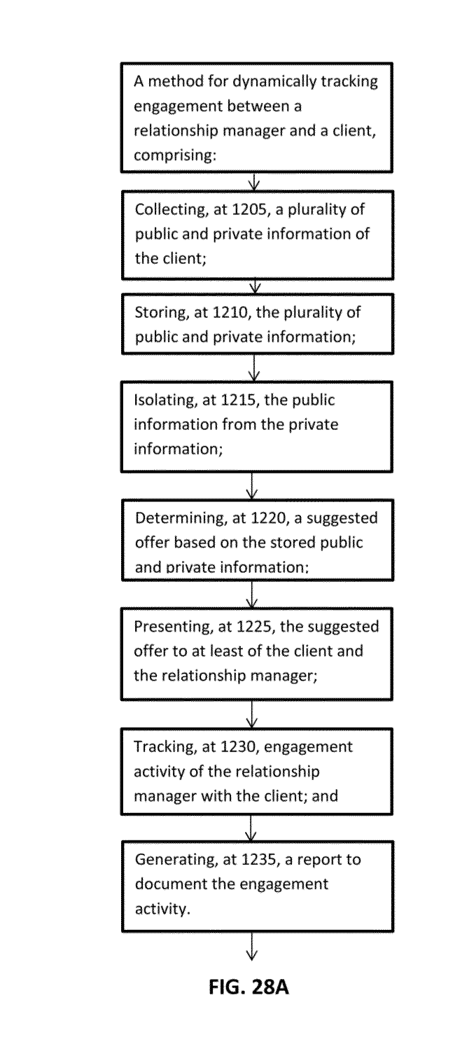

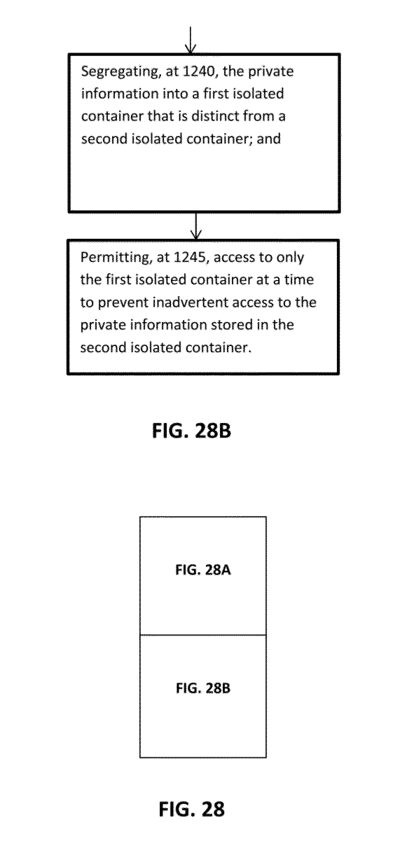

FIGS. 28A and 28B (collectively FIG. 28) are exemplary flow diagrams illustrating another embodiment of the method for dynamic client engagement. In this embodiment of the method 1200, said isolating further comprises segregating, at 1240, the private information into a first isolated container that is distinct from a second isolated container; and permitting, at 1245, access to only the first isolated container at a time to prevent inadvertent access to the private information stored in the second isolated container.

In one embodiment of the method 1200, the first isolated container can be any one of an isolated section of a first database on a first server, a second database on the first server, and a third database on a second server. In an embodiment of the method said permitting is accomplished through use of an identity specific domain name request with accompanying private encryption key specific for the first isolation container.

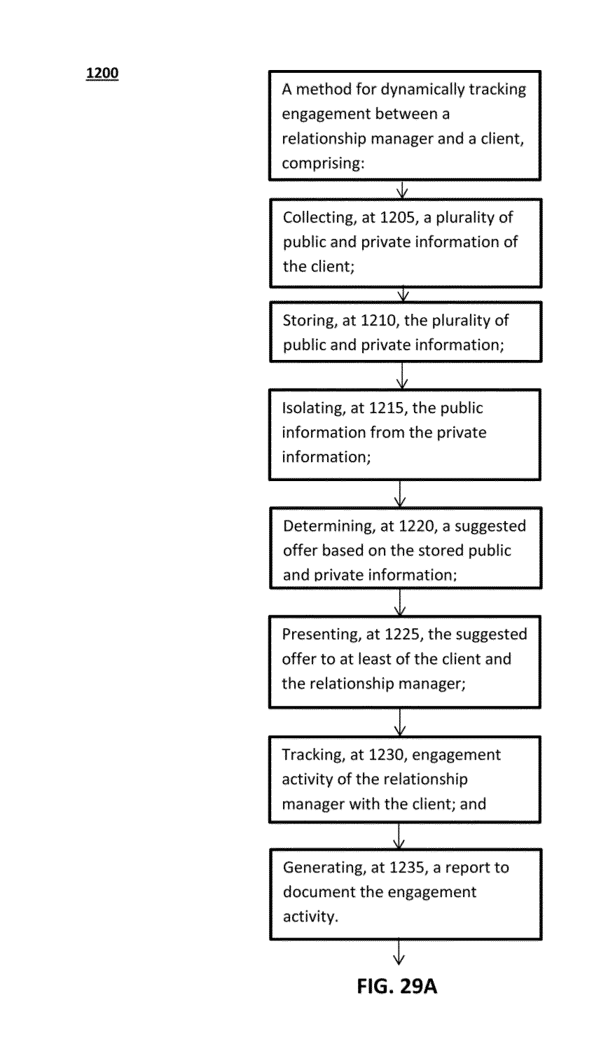

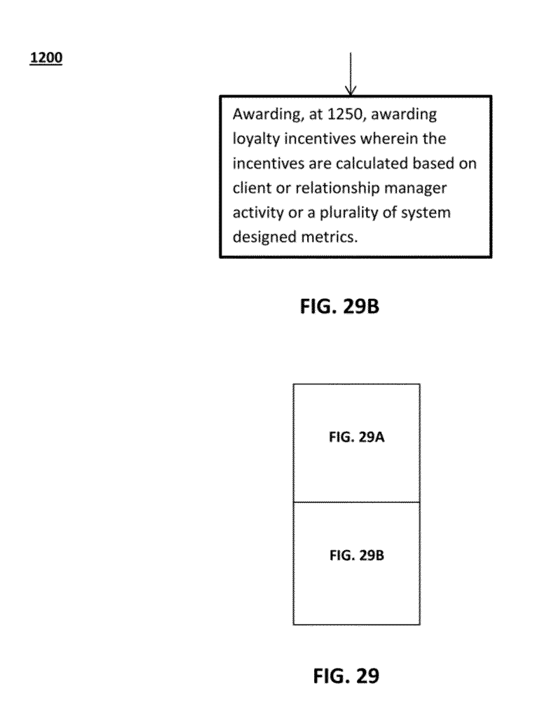

FIGS. 29A and 29B (collectively FIG. 29) are exemplary flow diagrams illustrating another embodiment of the method for dynamic client engagement. In the embodiment shown in FIG. 29, the method 1200 further comprises awarding loyalty incentives wherein the incentives are calculated based on client or relationship manager activity or a plurality of system designed metrics.

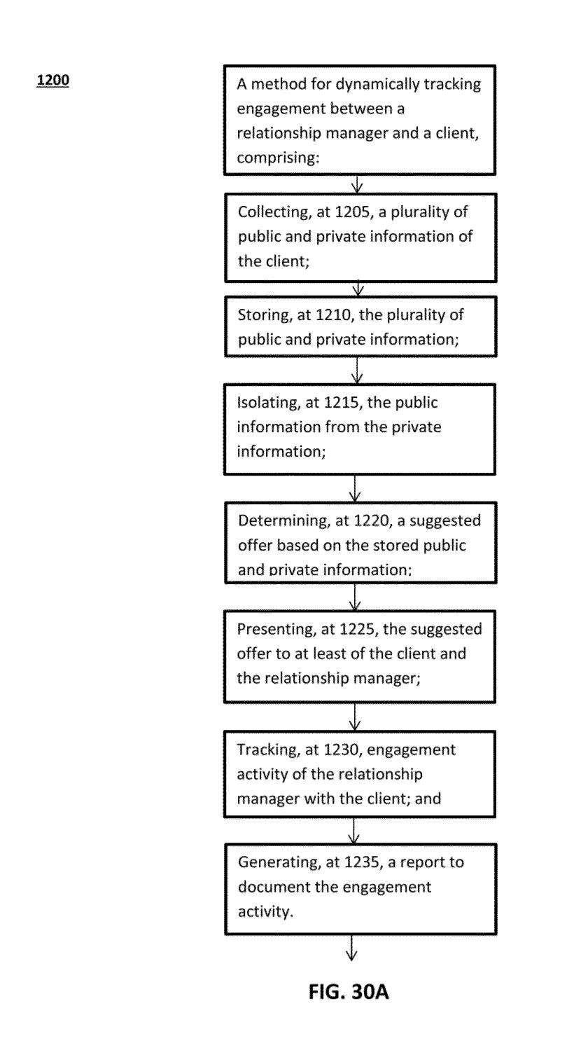

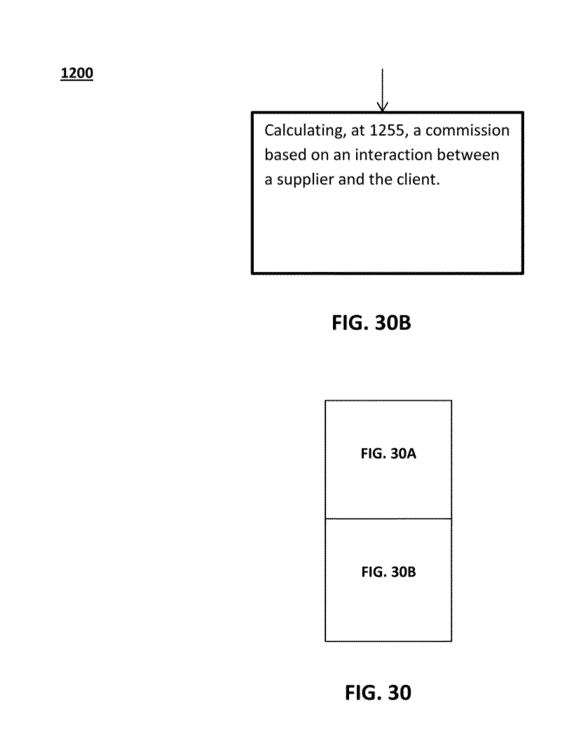

FIGS. 30A and 30B (collectively FIG. 30) are exemplary flow diagrams illustrating another embodiment of the method for dynamic client engagement. In the embodiment shown in FIG. 30, the method 1200 further comprises calculating, at 1255, a commission based on an interaction between a supplier and the client.

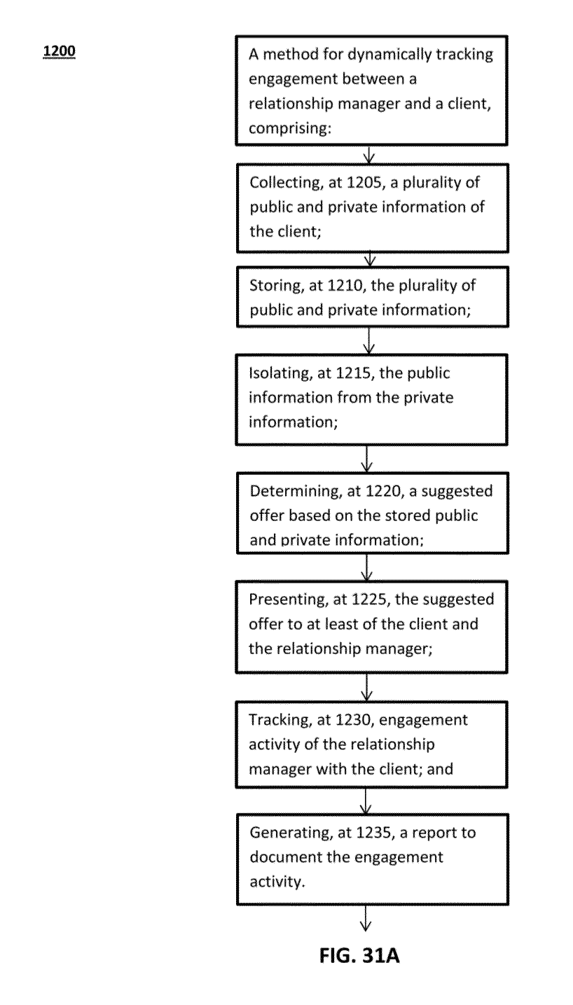

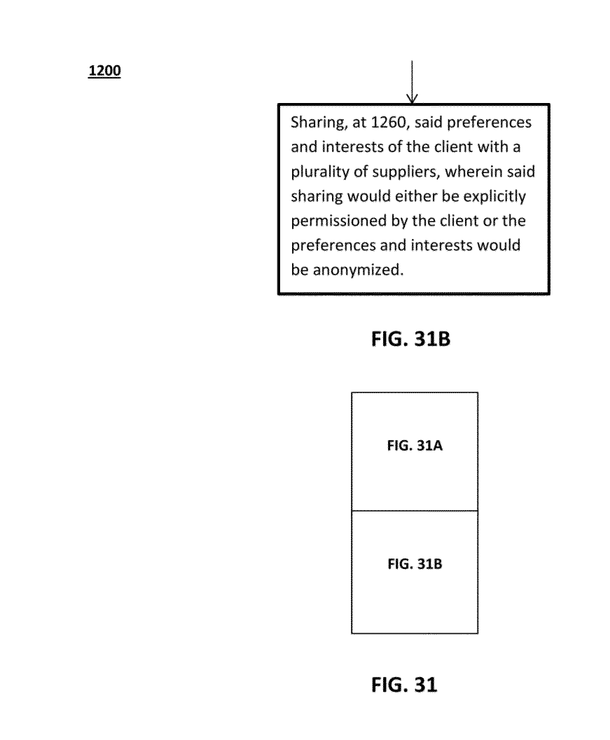

FIGS. 31A and 31B (collectively FIG. 31) are exemplary flow diagrams illustrating another embodiment of the method for dynamic client engagement. In the embodiment shown in FIG. 31, the method 1200 further comprises sharing, at 1260, said preferences and interests of the client with a plurality of suppliers, wherein said sharing would either be explicitly permissioned by the client or the preferences and interests would be anonymized.

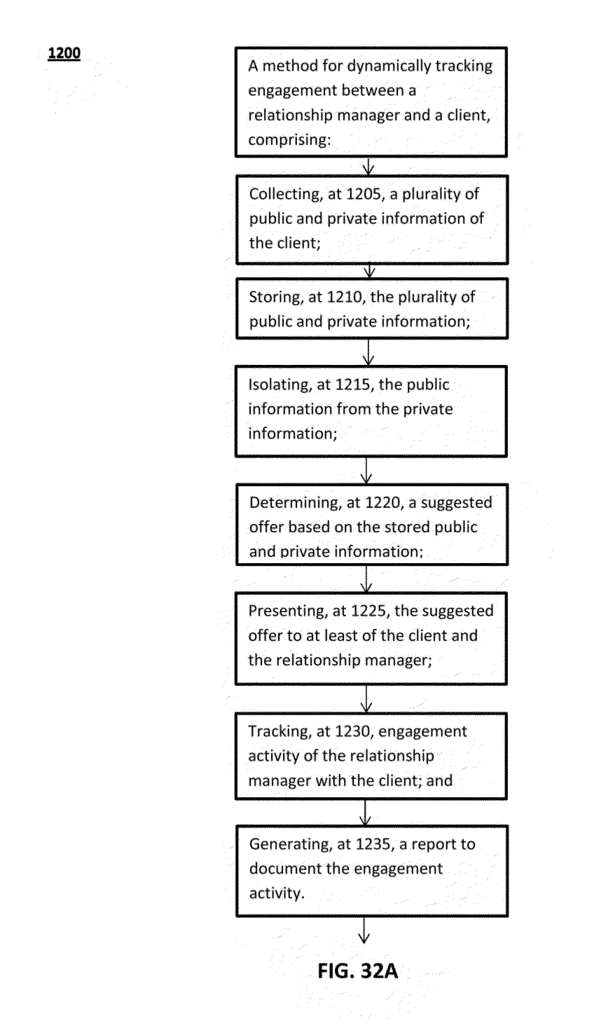

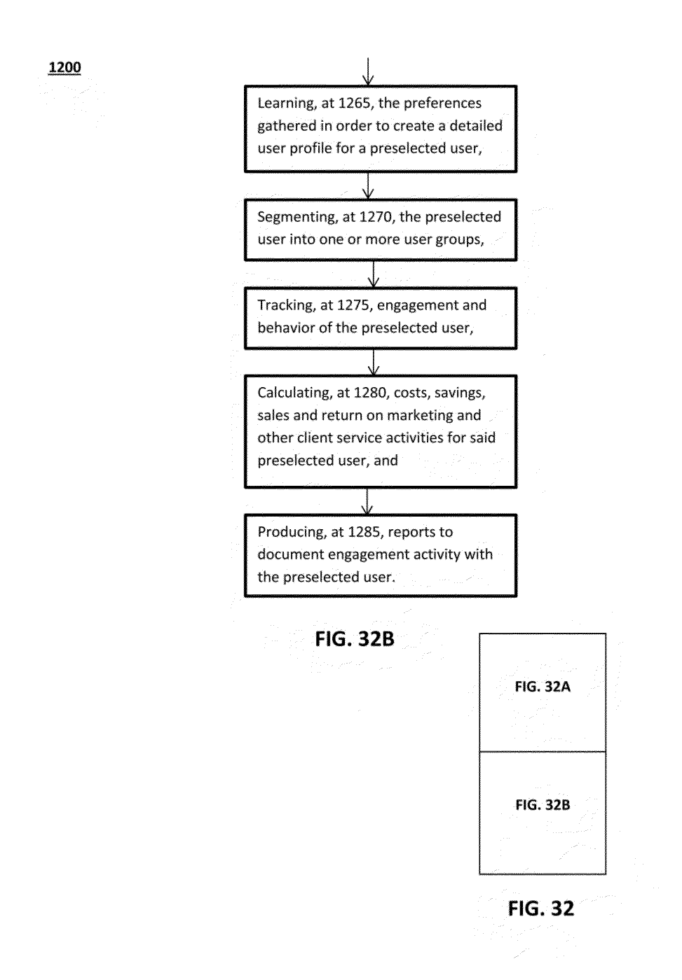

FIGS. 32A and 32B (collectively FIG. 32) are exemplary flow diagrams illustrating another embodiment of the method for dynamic client engagement. In the embodiment shown in FIG. 32, the method 1200 further comprises learning, at 1265, the preferences collected in order to create a detailed user profile for a preselected client, segmenting, at 1270, the preselected client into one or more user groups, qualifying the preselected client into a tier to ensure availability of appropriate offers only; tracking, at 1275, engagement and behavior of the preselected client, calculating, at 1280, costs, savings, sales, compliance value, and return on marketing and other client service activities for the preselected client, and producing, at 1285, reports to document engagement activity with the preselected client.

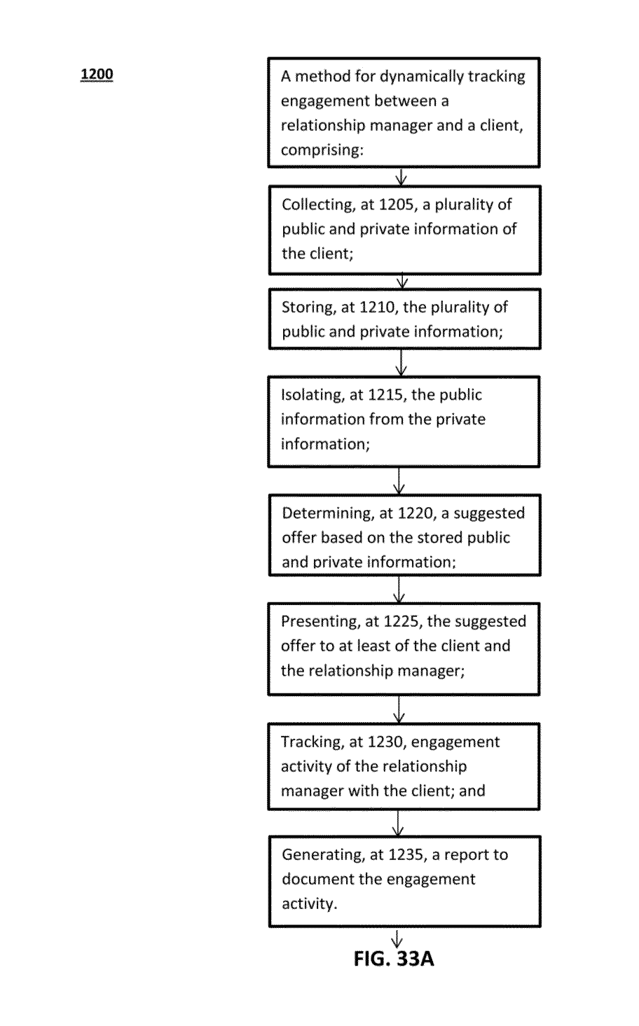

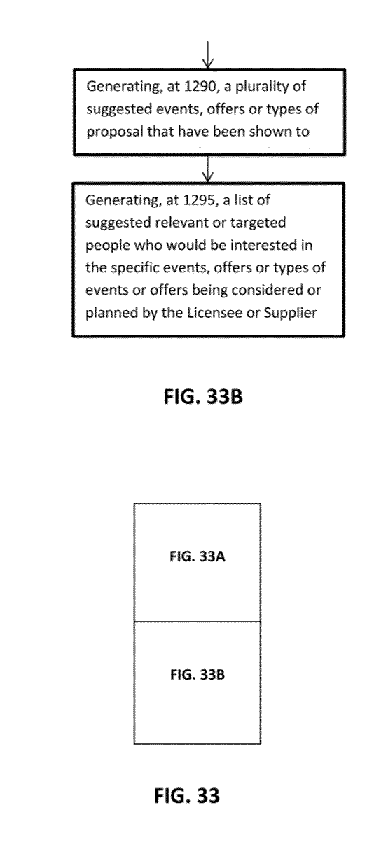

FIGS. 33A and 33B (collectively FIG. 33) are exemplary flow diagrams illustrating another embodiment of the method for dynamic client engagement. In the embodiment shown in FIG. 33, the method 1200 further comprises generating, at 1290, a plurality of suggested events, offers or types of proposals that have been shown to appeal to a specific group of people of commercial interest to a Licensee or Supplier, and generating, at 1295, a list or a group of suggested relevant or targeted people who would be interested in the specific events, offers or types of events or offers being considered or planned by the Licensee or Supplier.

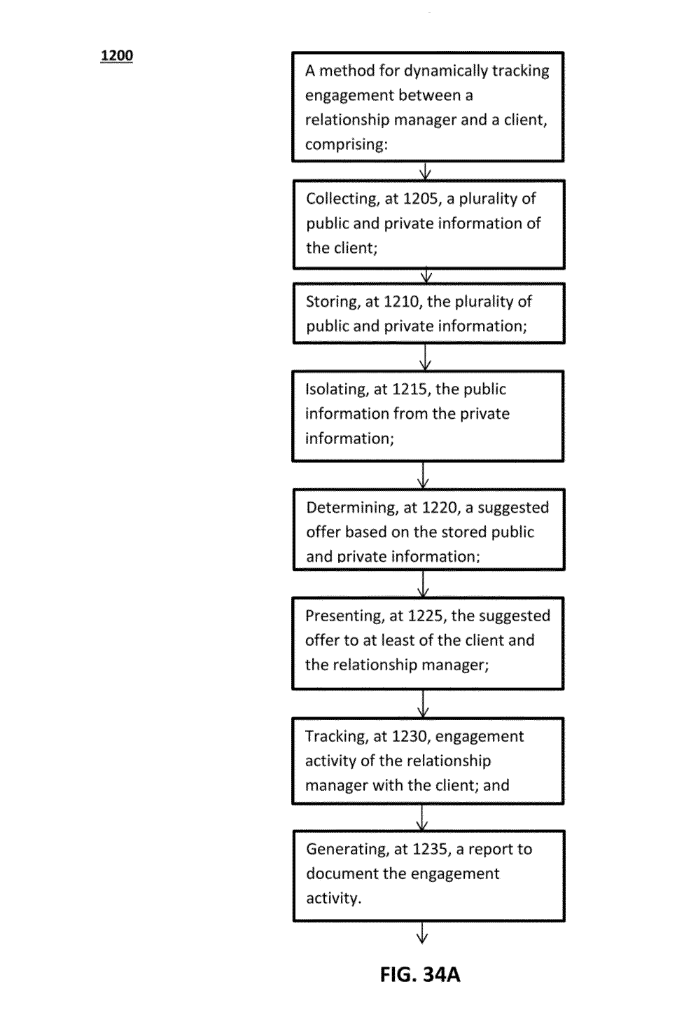

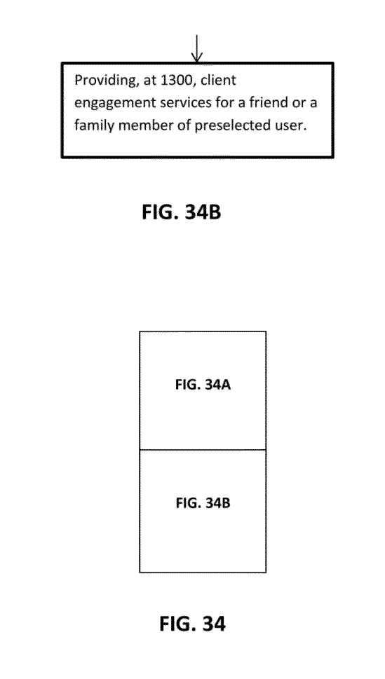

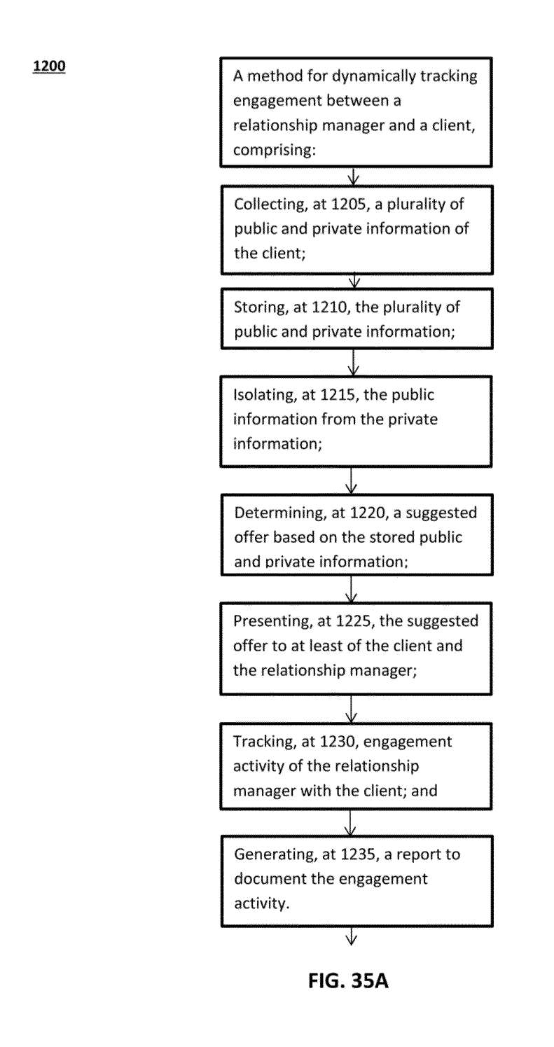

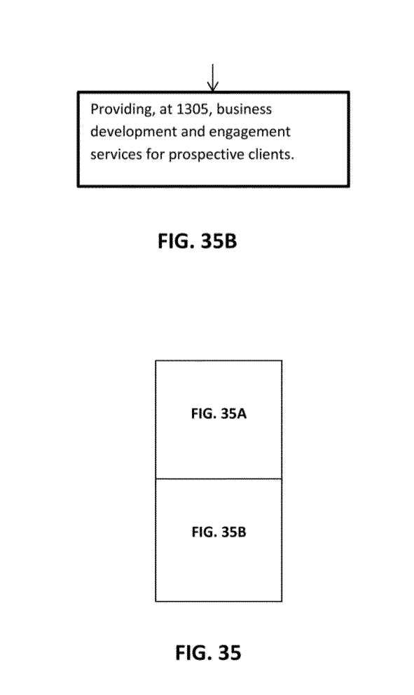

FIGS. 34A and 34B (collectively FIG. 34) are exemplary flow diagrams illustrating another embodiment of the method for dynamic client engagement. In the embodiment shown in FIG. 34, the method 1200 further comprises providing, at 1300, client engagement services for a friend or a family member of preselected user.

FIGS. 34A and 34B (collectively FIG. 34) are exemplary flow diagrams illustrating another embodiment of the method for dynamic client engagement. In the embodiment shown in FIG. 34, the method 1200 further comprises, providing, at 1305, business development and engagement services for prospective clients.

Another advantage of the disclosed system and method is a compliance calculation feature. The Compliance Cost will be used by Relationship Managers to disclose the cost of supporting each Client Relationship to ensure “appropriate spend” where appropriate will be separately determined by the company and audited across their client base. For every Confirmed Event, the direct cost, the cost price, the purchase price (inclusive of Tax, Administration Fee and Commission) and a compliance cost can be captured. The compliance cost can be then represented as either a Gift value (if the relationship manager did not attend the event) or an Engagement value (if the relationship manager attended the event). The Gift value or the Engagement value is simply the compliance cost/number of attendees for a Client.

Although the system does include traditional administration fee and commission calculations, additional features are supported for the specific Relationship Manager and Luxury Brand requirements. For Relationship Managers, the Purchase Value for an Event is translated into a Compliance Value that is defined as either a Gift or an Engagement Cost for a Client. For Luxury Brands, they may provide Complimentary Events where their compensation is defined by appropriately qualified Event Attendance. The system ensures that only appropriate individuals, as defined by their Tier, can be suggested to attend events. The suggestions are also linked to the client preferences to ensure appropriately qualified attendees. For Luxury Brands, they can provide Events to by Purchased, for these events the Event Costs are also captured allowing for Event Return on Investment to be calculated.

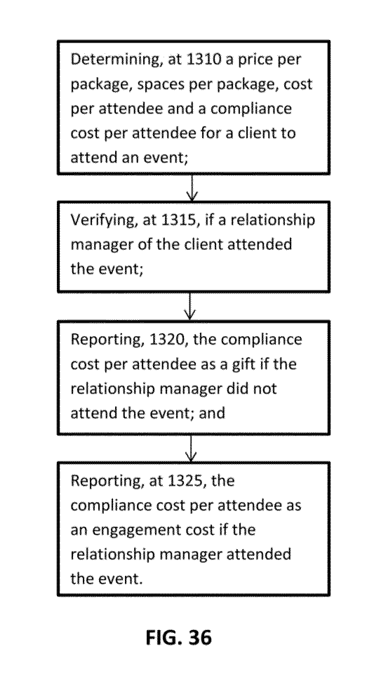

In another aspect disclosed herein and shown in FIG. 36, is a method for calculating compliance cost comprising determining, at 1310, a price per package, spaces per package, cost per attendee and a compliance cost per attendee for a client to attend an event; verifying, at 1315, if a relationship manager of the client attended the event; reporting, at 1320, the compliance cost per attendee as a gift if the relationship manager did not attend the event; and reporting, at 1325, the compliance cost per attendee as an engagement cost if the relationship manager attended the event.

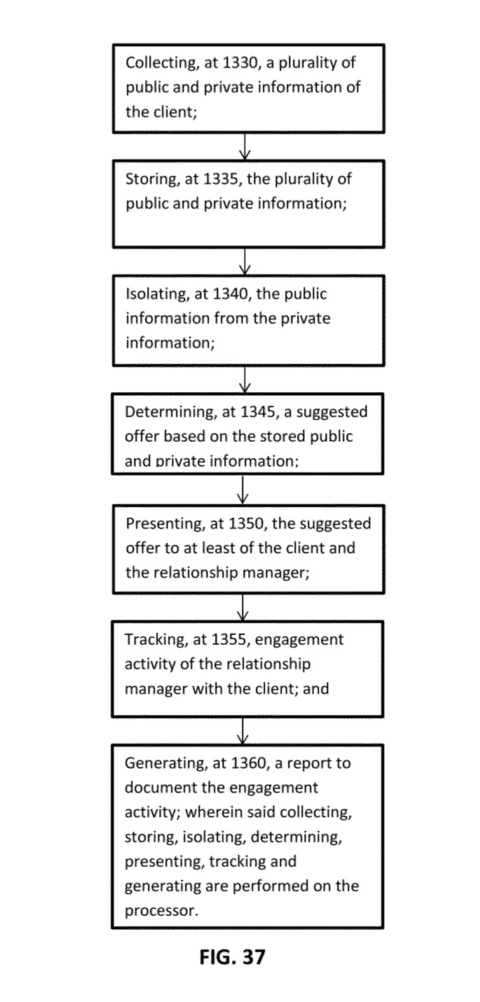

In another aspect disclosed herein and shown in FIG. 37, is a method for dynamically tracking engagement between a relationship manager and a client suitable for implementation on a processor, comprising collecting a plurality of public and private information of the client; storing the plurality of public and private information; isolating the public information from the private information; determining a suggested offer based on the stored public and private information; presenting the suggested offer to at least one of the client and the relationship manager; tracking engagement of a relationship manager with the client; and generating a report to document engagement activity with the client, wherein said collecting, storing, isolating, determining, presenting, tracking and generating are performed on the processor.

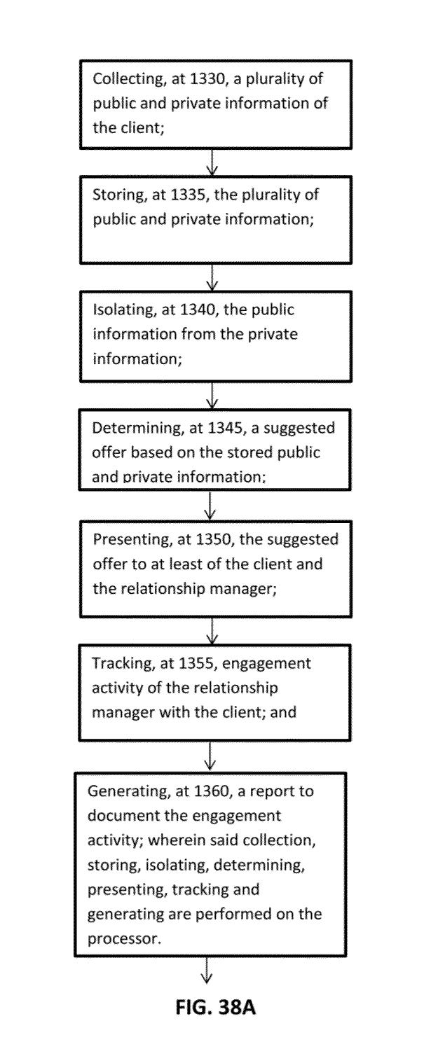

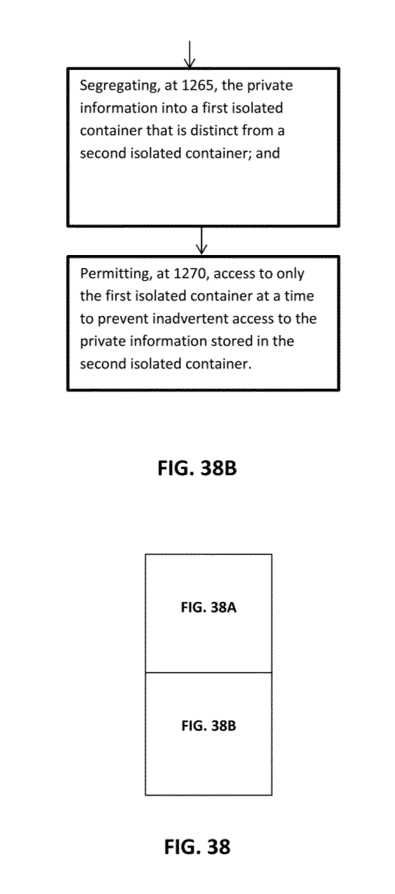

FIGS. 38A and 38B (collectively FIG. 38) are exemplary flow diagrams illustrating another embodiment of the method for dynamic client engagement. In the embodiment shown in FIG. 38, the method 1200 further comprises further comprises segregating, at 1265, the private information into a first isolated container that is distinct from a second isolated container; and permitting, at 1270, access to only the first isolated container at a time to prevent inadvertent access to the private information stored in the second isolated container.

In one embodiment of the method 1200, the first isolated container can be any one of an isolated section of a first database on a first server, a second database on the first server, and a third database on a second server. In an embodiment of the method said permitting is accomplished through use of an identity specific domain name request with accompanying private encryption key specific for the first isolation container.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of the appended claims.

What is claimed is:

1. A method for dynamically tracking engagement between a relationship manager and a client, comprising:
collecting a plurality of public and private information of the client;
storing the plurality of public and private information;
isolating the public information from the private information;
determining a suggested offer based on the stored public and private information;
presenting the suggested offer to at least one of the client and the relationship manager;
tracking engagement activity of the relationship manager with the client; and generating a report to document the engagement activity.

2. The method of claim 1 wherein said isolating further comprises:
segregating the private information into a first isolated container that is distinct from a second isolated container; and
permitting access to only the first isolated container at a time to prevent inadvertent access to the private information stored in the second isolated container.

3. The method of claim 2, wherein the first isolated container can be any one of an isolated section of a first database on a first server, a second database on the first server, and a third database on a second server.

4. The method of claim 2, wherein said permitting is accomplished through use of an identity specific domain name request with an accompanying private encryption key specific for the first isolation container.

5. The method of claim 1, wherein the private information includes the preferences and interests of the client.

6. The method of claim 1, further comprising presenting a suggested client for an offer to the relationship manager.

7. The method of claim 1, wherein the offer comprises a luxury good.

8. The method of claim 1, wherein the offer comprises access to a Prestige Organization.

9. The method of claim 1, wherein the offer comprises access to a co-sponsored event.

10. The method of claim 1, wherein the offer comprises at least one of an event ticket and an invitation for a special engagement.

11. The method of claim 1, wherein the offer comprises at least one of an experience and a privileged access.

12. The method of claim 1, wherein the offer comprises a privileged access to special arrangements relating to products, experiences or dedicated VIP client personnel.

13. The method of claim 1, further comprising awarding loyalty incentives wherein the incentives are calculated based on client or relationship manager activity or a plurality of system designed metrics.

14. The method of claim 1, further comprising calculating a commission based on an interaction between a supplier and the client.

15. The method of claim 5, further comprising sharing said preferences and interests of the client with a plurality of suppliers, wherein said sharing would either be explicitly permissioned by the client or the preferences and interests would be anonymized.

16. The method of claim 5, further comprising:
learning the preferences collected in order to create a detailed user profile for a preselected client,
segmenting the preselected client into one or more user groups,
qualifying the preselected client into a tier to ensure availability of appropriate offers only;
tracking engagement and behavior of the preselected client,
calculating costs, savings, sales, compliance value, and return on marketing and other client service activities for the preselected client, and
producing reports to document engagement activity with the preselected client.

17. The method of claim 1, further comprising:
generating a plurality of suggested events, offers or types of proposal that have been shown to appeal to a specific group of people of commercial interest to a Licensee or Supplier, and
generating a list or a group of suggested relevant or targeted people who would be interested in the specific events, offers or types of events or offers being considered or planned by the Licensee or Supplier.

18. The method of claim 1, further comprising,
providing client engagement services for a friend or a family member of a preselected client.

19. The method of claim 1, further comprising,
providing business development and engagement services for a prospective client.

20. A method of calculating a compliance cost, comprising:
determining a price per package, spaces per package, cost per attendee and a compliance cost per attendee for a client to attend an event;
verifying if a relationship manager of the client attended the event;
reporting the compliance cost per attendee as a gift if the relationship manager did not attend the event; and
reporting the compliance cost per attendee as an engagement cost if the relationship manager attended the event.

21. A method for dynamically tracking engagement between a relationship manager and a client suitable for implementation on a processor, comprising:
collecting a plurality of public and private information of the client;
storing the plurality of public and private information;
isolating the public information from the private information;
determining a suggested offer based on the stored public and private information;
presenting the suggested offer to at least one of the client and the relationship manager;
tracking engagement of a relationship manager with the client; and
generating a report to document engagement activity with the client,
wherein said collection, storing, isolating, determining, presenting, tracking and generating are performed on the processor.

22. The method of claim 21, wherein said isolation further comprises:
segregating the private information into a first isolated container that is distinct from a second isolated container; and
permitting access to only the first isolated container at a time to prevent inadvertent access to the private information stored in the second isolated container, wherein said segregating and permitting is performed on the processor.

23. The method of claim 22, wherein the distinct isolated container can be any one of an isolated section of a first database on a first server, a second database on the first server, and a third database on a second server.

24. The method of claim 22, wherein said permitting is accomplished through use of an identity specific domain name request with accompanying private encryption key specific for the first isolation container.
